(19) United States
(12) Patent Application Publication
(10) Pub. No.: US 2026/0113100 A1
(43) Pub. Date: Apr. 23, 2026

(54) METHODS FOR SPATIAL BLOCKAGE DETECTION AND PREDICTION

(71) Applicant: INTERDIGITAL PATENT HOLDINGS, INC., Wilmington, DE (US)

(72) Inventors: Tejaswinee Lutchoomun, Montreal (CA); Young Woo Kwak, Woodbury, NY (US); Nazli Khan Beigi, Longueuil (CA); Yugeswar Deenoo Narayanan Thangaraj, Chalfont, PA (US); Patrick Tooher, Montreal (CA); Prasanna Herath, Laval (CA); Moon IL Lee, Melville, NY (US); Haseeb Ur Rehman, Winnipeg (CA)

(73) Assignee: INTERDIGITAL PATENT HOLDINGS, INC., Wilmington, DE (US)

(21) Appl. No.: 19/116,960

(22) PCT Filed: Sep. 29, 2023
(86) PCT No.: PCT/US2023/034122

§ 371 Date: Mar. 28, 2025

Related U.S. Application Data
(60) Provisional application No. 63/411,427, filed on Sep. 29, 2022.

(51) Int. Cl. H04B 7/06; H04L 5/00; H04W 24/08; H04W 64/00

(52) U.S. Cl. CPC H04B 7/06964; H04L 5/0048; H04W 24/08; H04W 64/003

(57) ABSTRACT

Systems and methods for predictive wireless communication management. In some implementations, a wireless transmit/receive unit (WTRU) may establish communications with a network node via a first physical communication channel; and determine that a difference between measured characteristics of a reference signal and measured characteristics of a previous reference signal exceeds a reporting threshold. The WTRU may transmit, to the network node responsive to the determination, an identification of the measured characteristics of the reference signal; and may receive, from the network node via the first physical communication channel, an indication of predicted beam failure generated responsive to receipt of the identification of measured characteristics of the reference signal. The WTRU may reconfigure, responsive to receipt of the indication of predicted beam failure, communications with the network node to utilize a second physical communication channel.

### RELATED APPLICATIONS

The present application claims the benefit of and priority to U.S. Provisional Patent Application No. 63/411,427, entitled “Methods for Spatial Blockage Detection and Prediction,” filed Sep. 29, 2022, the entirety of which is incorporated by reference herein.

### SUMMARY

In several embodiments described herein there is approaches and techniques for handling blockages in a wireless medium. There may be reporting of the degradation in beam quality/channel conditions to detect/identify blockage, where a wireless transmit receive unit (WTRU) WTRU may undergo one or more corresponding changes following the detection of the blockage (e.g., when a machine learning model is at WTRU). Alternatively, there may be indications/requests received from a base station and corresponding changes in a WTRU's behavior (e.g., when ML model is at base station). In some cases, there may be additional information to identify other WTRUs impacted by the degradation. In one case, a determination that a machine learning model is not effective, and the system may switch to a legacy approach. In one case, a determination that a legacy mode is not effective, and the system may switch to a machine learning approach.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A illustrates an example of a machine learning model at a base station;

FIG. 2B is a flow chart of an implementation of a method for predictive wireless communication management, using a machine learning model at a base station;

FIG. 3A illustrates an example of a machine learning model at a WTRU;

FIG. 3B is a flow chart of an implementation of a method for predictive wireless communication management, using a machine learning model at a WTRU;

FIG. 4A illustrates an example of a machine learning model at a base station, where measurements in FR1 may result in blockage detection/prediction in FR2;

FIG. 4B is a flow chart of an implementation of a method for predictive wireless communication management across frequency resources, using a machine learning model at a base station;

FIG. 5A illustrates an example of a machine learning model at a WTRU, where measurements in FR1 may result in blockage detection/prediction in FR1;

FIG. 5B is a flow chart of an implementation of a method for predictive wireless communication management across frequency resources, using a machine learning model at a WTRU.

### DETAILED DESCRIPTION

Table 1 provides an example, non-exhaustive, list of acronyms that may be used herein.

TABLE 1

| | |
|---|---|
| Δf | Sub-carrier spacing |
| gNB | NR NodeB |
| AP | Aperiodic |
| BFR | Beam Failure Recovery |
| BFD-RS | Beam Failure Detection-Reference Signal |
| BLER | Block Error Rate |
| BWP | Bandwidth Part |
| CA | Carrier Aggregation |
| CB | Contention-Based (e.g. access, channel, resource) |
| CBRA | Contention-Based Random Access |
| CCA | Clear Channel Assessment |
| CDM | Code Division Multiplexing |
| CFRA | Contention-Free Random Access |
| CG | Cell Group |
| CLI | Cross Layer Interference |
| CoMP | Coordinated Multi-Point transmission/reception |
| COT | Channel Occupancy Time |
| CP | Cyclic Prefix |
| CPE | Common Phase Error |
| CP-OFDM | Conventional OFDM (relying on cyclic prefix) |
| CQI | Channel Quality Indicator |
| CN | Core Network (e.g. LTE packet core or NR core) |
| CRC | Cyclic Redundancy Check |
| CSI | Channel State Information |
| CSI-RS | Channel State Information-Reference Signal |
| CU | Central Unit |
| D2D | Device to Device transmissions (e.g. LTE Sidelink) |
| DC | Dual Connectivity |
| DCI | Downlink Control Information |
| DL | Downlink |
| DM-RS | Demodulation Reference Signal |
| DRB | Data Radio Bearer |
| DU | Distributed Unit |
| EN-DC | E-UTRA - NR Dual Connectivity |
| EPC | Evolved Packet Core |
| FD-CDM | Frequency Domain-Code Division Multiplexing |
| FDD | Frequency Division Duplexing |
| FDM | Frequency Division Multiplexing |
| ICI | Inter-Cell Interference |
| ICIC | Inter-Cell Interference Cancellation |
| IP | Internet Protocol |
| LBT | Listen-Before-Talk |
| LCH | Logical Channel |
| LCID | Logical Channel Identity |
| LCP | Logical Channel Prioritization |
| LLC | Low Latency Communications |
| LTE | Long Term Evolution e.g. from 3GPP LTE R8 and up |
| MAC | Medium Access Control |
| MAC CE | Medium Access Control Control Element |
| NACK | Negative ACK |
| MBMS | Multimedia Broadcast Multicast System |
| MCG | Master Cell Group |
| MCS | Modulation and Coding Scheme |
| MIMO | Multiple Input Multiple Output |
| MTC | Machine-Type Communications |
| MR-DC | Multi-RAT Dual Connectivity |
| NAS | Non-Access Stratum |
| NCB-RS | New candidate beam-Reference Signal |
| NE-DC | NR-RAN - E-UTRA Dual Connectivity |
| NR | New Radio |
| NR-DC | Dual Connectivity with |
| OFDM | Orthogonal Frequency-Division Multiplexing |
| OOB | Out-Of-Band (emissions) |
| Pcmax | Total available UE power in a given transmission interval |
| Pcell | Primary cell of Master Cell Group |
| PCG | Primary Cell Group |
| PDU | Protocol Data Unit |
| PER | Packet Error Rate |
| PHY | Physical Layer |
| PLMN | Public Land Mobile Network |
| PLR | Packet Loss Rate |
| PRACH | Physical Random-Access Channel |
| PRB | Physical Resource Block |
| PRS | Positioning Reference Signal |
| Pscell | Primary cell of a Secondary cell group |
| PSS | Primary Synchronization Signal |
| PT-RS | Phase Tracking-Reference Signal |
| QoS | Quality of Service (from the physical layer perspective) |
| RAB | Radio Access Bearer |
| RAN PA | Radio Access Network Paging Area |
| RACH | Random Access Channel (or procedure) |
| RAR | Random Access Response |
| RAT | Radio Access Technology |
| RB | Resource Block |
| RCU | Radio access network Central Unit |
| RF | Radio Front end |
| RE | Resource Element |
| RLF | Radio Link Failure |
| RLM | Radio Link Monitoring |
| RNTI | Radio Network Identifier |
| RO | Random Access Occasion |
| ROM | Read-Only Mode (for MBMS) |
| RRC | Radio Resource Control |
| RRM | Radio Resource Management |
| RS | Reference Signal |
| RTT | Round-Trip Time |
| SCG | Secondary Cell Group |
| SCMA | Single Carrier Multiple Access |
| SCS | Sub-Carrier Spacing |
| SDU | Service Data Unit |
| SOM | Spectrum Operation Mode |
| SP | Semi-persistent |
| SpCell | Primary cell of a master or secondary cell group. |
| SRB | Signaling Radio Bearer |
| SS | Synchronization Signal |
| SRS | Sounding Reference Signal |
| SSS | Secondary Synchronization Signal |
| SUL | Supplementary UpLink |
| SWG | Switching Gap (in a self-contained subframe) |
| TB | Transport Block |
| TBS | Transport Block Size |
| TCI | Transmission Configuration Index |
| TDD | Time-Division Duplexing |
| TDM | Time-Division Multiplexing |
| TI | Time Interval (in integer multiple of one or more symbols) |
| TTI | Transmission Time Interval (in integer multiple of one or more symbols) |
| TRP | Transmission / Reception Point |
| TRPG | Transmission / Reception Point Group |
| TRS | Tracking Reference Signal |
| TRx | Transceiver |
| UL | Uplink |
| URC | Ultra-Reliable Communications |
| URLLC | Ultra-Reliable and Low Latency Communications |
| V2X | Vehicular communications |
| WLAN | Wireless Local Area Networks and related technologies (IEEE 802.xx domain) |
| XDD | Cross Division Duplex |

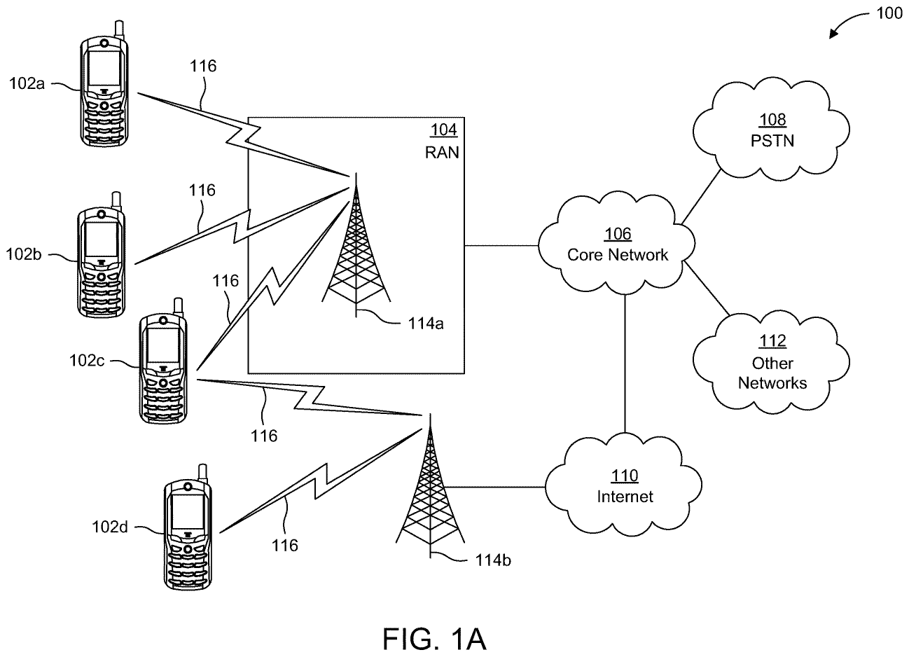

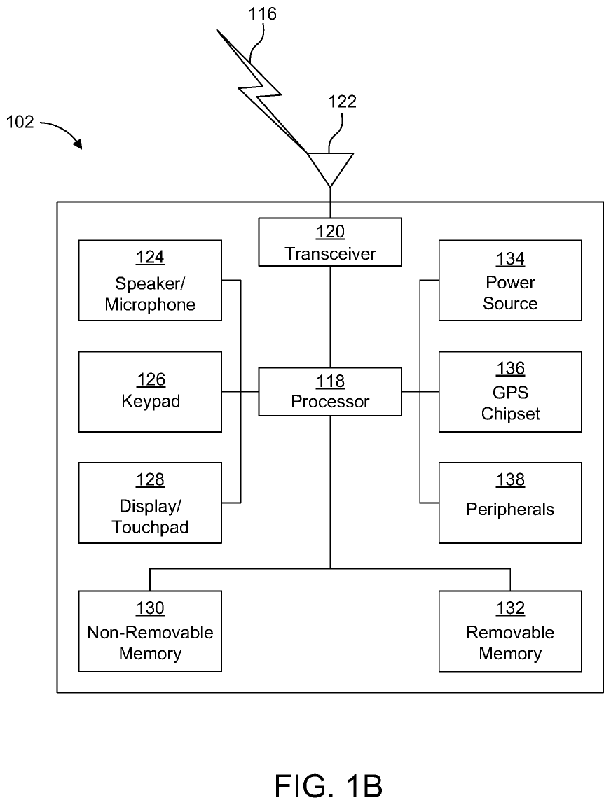

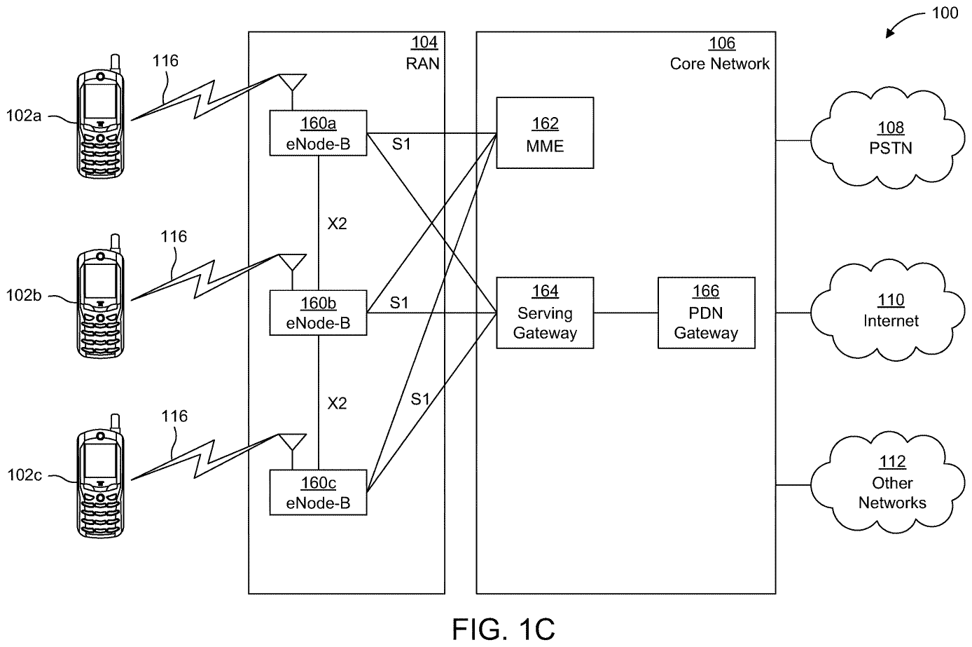

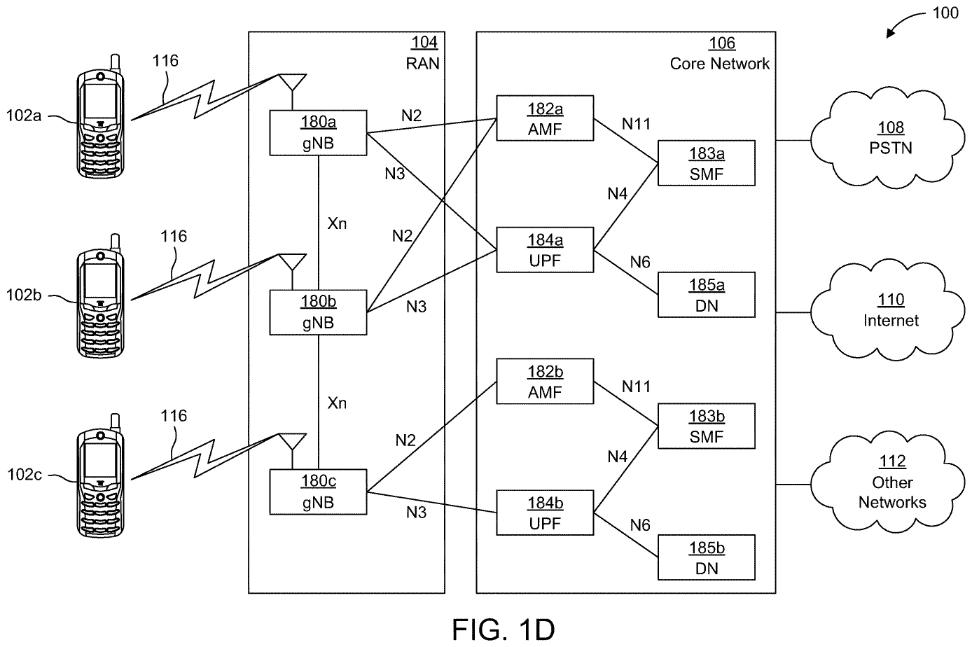

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), and the like. While the base stations 114a, 114b are each depicted as a single element, it will be appreciated that the base stations 114a, 114b may include any number of interconnected base stations and/or network elements. A TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with this disclosure.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB, a gNB, etc.).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

Generally in view of any of the examples shown in FIGS. 1A-1D, the WTRU (e.g., 102, 102a, etc.) may transmit or receive a physical channel or reference signal according to at least one spatial domain filter. The term “beam” may be used to refer to a spatial domain filter. Additionally, as discussed herein a beam may represent a receiver beam, a transmitter beam, or a beam-pair.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

Generally, any network side device/node/function/base station, in FIGS. 1A-1D, and/or described anywhere herein, may be interchangeable, and reference to the network may refer to a specific entity on the network side (e.g., in a communication between a WTRU and a network entity, such as a base station), as disclosed herein, such as a device, node, function, base station, cloud, or the like. This may help illustrate communication between the WTRU and nodes on the network.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some cases, Artificial Intelligence (AI)/Machine Learning (ML) techniques may be used in wireless communication system to increase efficiency and improve various aspects of the system. For example, air interface improvements, such as AI/ML beam management. Such application may improve performance and complexity in conventional beam management aspects, including beam prediction in time, and/or spatial domain for overhead and latency reduction, beam selection accuracy improvement, and so forth.

Artificial intelligence may be broadly defined as processing, analytics, and actions exclusively performed by a computer in order to mimic cognitive functions to sense, reason, adapt, and/or act. Machine learning may refer to type of approach to solve a problem based on learning through experience (‘data’), based on varying degrees of programming (e.g., no external input, minimal external input, input intended to guide, etc.). Machine learning can be considered to be a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning refers to class of machine learning algorithms that employ artificial neural networks (e.g., Deep Neural Networks) which may be loosely inspired from biological systems, but are implemented in a processor and/or a distributed computing setup. The Deep Neural Networks (DNNs) are a special class of machine learning models inspired by the human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, such as speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

In non-AI/ML beam management, selection may be based on beam sweeping at the base station-side and WTRU-side and selection of the best beam pair. AI/ML based beam selection mechanisms in time domain can benefit from knowledge of current/upcoming obstructions/blockages to address the blockage issue in FR1 and/or FR2, and assist the base station and WTRU in preparing an unblocked beam pair in advance. As disclosed herein, ‘obstacle’ and ‘blockage’ may be used interchangeably to refer to any spatial object/event resulting in either partial or complete degradation in channel quality/beam quality measurements between the WTRU and base station and/or TRP.

In some cases, during periodic reporting of a best beam index, a WTRU may send at specified time intervals measurement reports that include RSRP and identifiers of the measured beams. The base station may pick the strongest beam reported by the WTRU as the serving beam, until the next measurement report. That may limit the agility of the base station to react to changes in signal quality especially if a beam pair is rapidly blocked by an obstacle and there is not sufficient time for regular beam adjustment procedures. Each time the measured RSRP is below a configured value, a beam failure instance may be declared by the WTRU. If the number of such instances exceeds a configured value, the WTRU may declare beam(s) failure and initiate a beam recovery procedure to find a new beam pair where the connectivity could be restored. However, this process may result in service interruption or increased latency for packet delivery and lowered throughput.

In at least one scenario, during periodic reporting of the best beam index, a WTRU may send at specified time intervals measurement reports that include RSRP and identifiers of the measured beams. The base station may pick the strongest beam reported by the WTRU as the serving beam, until the next measurement report. This may limit the agility of the base station to react to changes in signal quality especially if a beam pair is rapidly blocked by a blockage/obstacle and there is no sufficient time for regular beam adjustment procedures. Each time the measured RSRP is below a configured value, a beam failure instance is declared by the WTRU. If the number of such instances exceeds a configured value, the WTRU may declare beam(s) failure and initiates the beam recovery procedure to find a new beam pair where the connectivity could be restored. However, this process may result in service interruption or increased latency for packet delivery and lowered throughput. There is a need for detecting/predicting the next obstacles, TRPs and/or base stations serving a WTRU so that beam and radio link failures can be avoided and time and frequency resources needed for recovery can be saved.

TRPs and/or base stations may use measurements/reports from one WTRU to identify/detect blockages that may impact surrounding WTRUs. Using FR1 measurements to predict FR2 blockages may enable blockage prediction with lower overhead, especially in cases where the WTRU and base station may be dual-band systems employing both sub-6 GHZ and mmWave transceivers.

ML model at a base station may be able to predict the next obstacle at periodic intervals at a frequency that is higher than that of the measurement reporting frequency of the WTRU (e.g., since a base station may have access to data from multiple WTRUs).

Knowledge of predicted blockage may assist a WTRU in a plurality of ways, such as: Triggering beam change or beam failure recovery procedure ahead of time; and/or hand of communication session to the sub-6 GHZ band.

Knowledge may assist a base station in adapting its transmission strategy in a plurality of ways, such as: Change transmit power; Change modulation/coding scheme; Hand of communication session to the sub-6 GHz band; and/or pre-emptive handover to another base station.

There is a need to address how to support spatial blockage detection/prediction based on measurements at the WTRU using AIML models at the WTRU and/or base station, and a need for related techniques.

Generally, an AIML model may be generated/operated from a WTRU and/or base station (e.g., either side may perform the modeling, although input/output may come from or go to destinations as needed). During a training phase, the AI/ML blockage/obstacle prediction model may learn about mobility patterns of a transmitter, receiver, scatterers and predict blockages before it blocks the LOS path, from the Channel Impulse response, or any of the input listed herein. The ML model may identify/detect and/or predict blockages/obstacles in a spatial region. The training may be adapted/trained to static and/or dynamic blockages/obstacles.

Input options to an AIML model during runtime may include: Channel impulse response of sub-6 GHZ channel containing information about the propagation paths of signals (e.g., corresponding to obstacles/blockages); WTRU reporting of information on Tx beams (e.g., Tx beam index/RSRP/RSRP drop); WTRU reporting of information on Rx beams (e.g., Rx beam index/RSRP/RSRP drop); WTRU reporting of CSI parameters (e.g., CQI, PMI, RI) for FR1 channel measurements that may be used for blockage prediction in FR1 and/or FR2; and/or WTRU reporting of “worst beams” or worst measured channel parameter, such as “worst PMI”, (e.g., corresponding to blockages/obstacles).

An AIML model may: detect/predict blocked obstacles in spatial region, in FR1 and/or FR2; determine gNB side Tx beams impacted by blockage/obstacle; and/or determine WTRU side Rx beams that may be impacted by blockage/obstacle.

Output options of an AIML model may include: a list of beams (e.g., beam index) impacted by blockage/obstacle due to static or dynamic blockages in FR1 (and/or FR2); an indication/probability of blocked/unblocked status of specific beams (e.g., indicated via beam index); and/or an indication/probability of blocked/unblocked status in the case of joint ML model for beam and blockage prediction.

An AIML blockage prediction model may be a standalone model trained for blockage/obstacle detection and prediction.

An AIML blockage prediction model may be part of a joint beam and blockage prediction model whereby the input to the first (N-k) layers may be a beam codebook with a pre-defined set of options for best beams. The output of the first (N-k) layers may be the ‘best’ beams, which may then be input into the last k layers of the ML model for the blockage prediction part, whereby the output may be a binary set of blocked/unblocked status for each beam output from the first (N-k) layers.

Such a NN architecture may reduce the computational burden of training process and training overhead, and give faster convergence.

The weights of beam prediction NN may be used to initialize nodes for blockage prediction in training. The end stack (last k layer(s)) may need to be trained from scratch.

In some cases, there may be information exchange between a WTRU and a base station to identify other WTRUs that may be impacted about a blockage. In one case, the WTRU may send information to the base station to identify other WTRUs that may also be impacted by the blockage/obstacle. For example, the WTRU may receive a configuration of RS resources/resource sets (e.g., SRS) and associated configurations (e.g., TA, power control parameters and etc.) from the base station and/or a first WTRU to determine whether it's close enough to be experiencing similar propagation effects/channel conditions. Based on the configuration, the WTRU may measure the RS resources/resource sets from the first WTRU and report the measurement result to the base station.

The WTRU may measure the RS resources/resource sets based on the received TA (e.g., N symbols). In one instance, the TA may be an absolute value. For example, the WTRU may receive the RS resource by applying the received TA from the timing based on SSB reception. In another instance, the TA may be a differential value. For example, the WTRU may receive the RS resources by using the following equation: Final TA value=original TA of the WTRU− (or +) the differential TA.

In another case, the WTRU may derive a required TA value by receiving one or more RS resources/resource sets (e.g., PRACH). For example, the WTRU may receive a configuration of one or more RS resources/resource sets. The WTRU may receive the one or more RS resources/resource sets based on the configuration and determine one or more TA values for measurement of WTRU reporting. Based on the measurement, the WTRU may apply the determined TA values.

The WTRU may report to the base station whether it is close enough or not to the first WTRU. For example, the WTRU may report assessment/determination of proximity/likelihood to experience similar channel conditions to the base station. The assessment/determination of proximity/likelihood may be based on the position of the WTRU based on one or more of the following: Distance/radius (e.g., if the distance between the WTRU and the first WTRU is smaller than a threshold, the WTRU may report that the first WTRU is close enough); and/or channel quality measurement metrics (e.g., if the measured channel quality measurement metrics, such as RSRP/RSRQ/SINR/etc., is larger than (or equal to) a threshold, the WTRU may report that the first WTRU is close enough, or such as if the measured channel quality measurement metrics (e.g., pathloss) is smaller than (or equal to) a threshold, the WTRU may report that the first WTRU is close enough.

The WTRU reporting may be binary (e.g., 1-bit reporting on whether the WTRU is close enough or not to a first WTRU) or more granular (e.g., more accurate 2-bit reporting).

The WTRU may directly exchange information with other WTRUs via a SL interface. The information exchanged by the WTRU may involve information to assist the other WTRU in assessing/determining whether the blockage detected/predicted by the WTRU may impact the other WTRU(s). Examples, the information may include zone/area indexes, any DL RS measurement that the first WTRU may have already made which may benefit the other WTRU such that the other WTRU does not have to make similar measurements and so on.

In some cases, the WTRU may determine it relative position from another WTRU to a base station. In one case, a first WTRU may transmit an RS (e.g., SRS) in one or more RS resources to a second WTRU. The second WTRU may receive a corresponding RS-config (e.g., SRS-Config) and/or a relative timing advance (TA) from the first WTRU for timing synchronization. The second WTRU may perform measurements (e.g., LOS probability, pathloss, RSRP, CQI) on the received RS from the first WTRU. Based on the measurements, the second WTRU may determine its relative position from the first WTRU.

The second WTRU may report its relative position from the first WTRU to the base station.

The second WTRU may be indicated a granularity level for position reporting by the base station and/or by the first WTRU (e.g., through SRS-Config).

The second WTRU may be configured with a set of granularity levels and may choose a granularity level for reporting based on at least one of: SCS, carrier frequency, or LOS probability.

In one instance, the WTRU may report its relative position from another WTRU with high granularity level for high SCS, carrier frequency (e.g., FR-2) and/or LOS probability (e.g., LOS probability greater than a threshold). For example, the second WTRU may report with four levels (e.g., 2-bit) of relative positions based on position/distance thresholds. The second WTRU may report its relative position within: the first level when its distance from the first WTRU is less than a threshold d1; the second level when its distance from the first WTRU is greater than d1 but less than a threshold d2; the third level when its distance from the first WTRU is greater than d2 but less than a threshold d3; and/or the fourth level when its distance from the first WTRU is greater than d3; where d1 is less than d2, and d2 is less than d3.

In one instance, the WTRU may report its relative position from another WTRU with low granularity level for low SCS, carrier frequency (e.g., FR-1) and/or LOS probability (e.g., LOS probability smaller than a threshold). For example, the second WTRU may report 1-bit relative position based on a position/distance threshold. The second WTRU may report a value 1 when its distance from the first WTRU is less than a threshold d1, and 0 otherwise.

A WTRU may use/receive/or be configured with one or more sets of reference signals per BWP for monitoring, detecting, and/or predicting the beam and/or radio link failure. For example, the term q0 may be used for the beam failure detection/prediction set. In another example, the terms q0,0 or q0, 1 may be used as the beam failure detection/prediction sets. The beam failure detection/prediction sets (e.g., set q0, q0,0, or q0,1) may include one or more reference signals, wherein the reference signals may be CSI-RS resource configuration indexes and/or SS/PBCH block (SSB) indexes. The reference signals included in beam failure detection/prediction RS sets may be the same as the reference signals configured/used/received for Radio Link Monitoring (RLM).

If a WTRU is not provided/configured with beam failure detection/prediction RS sets for a BWP (e.g., set q0, q0,0, or q0,1), the WTRU may determine the respective RS sets. For example, the WTRU may determine the RS signals to be included in a beam failure detection/prediction RS set for a BWP based on the periodic CSI-RS resource configuration indexes that the WTRU uses for monitoring PDCCH in the respective CORESETs as indicated by TCI-state.

The WTRU may measure the reference signals included in beam failure detection RS sets and estimate/predict radio link quality accordingly. The WTRU may use one or more thresholds/ranges for monitoring, estimating, and predicting the radio link quality. In an example, a WTRU may use an AI/ML framework for beam failure prediction. As an instance, the WTRU may be configured with out-of-sync threshold (e.g., Q_out) and/or in-sync threshold (e.g., Q_in), wherein the thresholds Q_out and/or Q_in may be used (e.g., via AI/ML) for estimating/predicting the quality and/or probability of failure of the radio link and/or respective beam. The terms Q_out and Q_in may be used to represent one or more attributes and parameters and the respective values.

The threshold Q_out may be used to determine the radio link and/or beam quality and/or probability of failure for which the signal transmission may not be reliably received, corresponding to out-of-sync block error rate (BLER_out). Alternatively, threshold Q_in may be used to determine the radio link and/or beam quality and/or probability of failure for which the signal transmission may be received reliably, corresponding to in-sync block error rate (BLER_in). The BLER_out and/or BLER_in may be explicitly determined by base station.

Alternatively, the BLER_out and/or BLER_in may be determined as a part of a processing procedure (e.g., AI/ML). In an example, the BLER_out and/or BLER_in parameters may be estimated/determined/predicted based on one or more parameters. For example, the WTRU may use, receive, or be configured with PDCCH transmission parameters for performing the out-of-sync and/or in-sync evaluations. In an example, the number of control OFDM symbols, aggregation level, ratio of hypothetical PDCCH RE energy to average SSS RE energy, ratio of hypothetical PDCCH DMRS energy to average SSS RE energy, BWP in number of PRBs, subcarrier spacing, and so forth may be used for determining the BLER_out and/or BLER_in thresholds.

In some cases, a WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: CSI Report Configuration; CSI-RS Resource Set; and/or NZP CSI-RS Resources.

A CSI Report Configuration may include one or more of the following: CSI report quantity (e.g., Channel Quality Indicator (CQI), Rank Indicator (RI), Precoding Matrix Indicator (PMI), CSI-RS Resource Indicator (CRI), Layer Indicator (LI), etc.); CSI report type (e.g., aperiodic, semi persistent, periodic); CSI report codebook configuration (e.g., Type I, Type II, Type II port selection, etc.); and/or CSI report frequency.

A CSI-RS Resource Set may include one or more of the following: NZP-CSI-RS Resource for channel measurement; NZP-CSI-RS Resource for interference measurement; and/or CSI-IM Resource for interference measurement,

NZP CSI-RS Resources may include one or more of the following: NZP CSI-RS Resource ID; Periodicity and offset; QCL Info and TCI-state; and/or Resource mapping (e.g., number of ports, density, CDM type, etc.).

Herein, disclosed parameters are non-limiting examples of the parameters that may be included in evaluating the out-of-sync and in-sync thresholds. One or more of those parameters may be included. The values and choices for each parameter are examples. Other values or choices may be included.

Herein, the terms, parameters, and signaling for beam failure prediction, beam blockage prediction, probability of beam failure prediction, and/or probability of beam blockage prediction may be used interchangeably and still consistent with this disclosure.

Upon detection/prediction of a beam failure or radio link failure, a WTRU may measure one or more candidate beams to select the best/optimal beam and report to base station. In one or more examples/embodiments disclosed herein, there may be one or more procedure(s)/device(s)/system(s) for a WTRU to indicate/report a beam that is predicted to have blockage, beam and/or radio link failure.

A WTRU may determine or be configured to perform measurements and predictions (e.g., via AI/ML model) on (e.g., probability of) the beam/radio link failure for one or more beam resources. As referenced herein, a beam resource may comprise of a TCI state, CSI-RS or a SSB for downlink, an SRS resource or TCI state for uplink. The WTRU may be configured with one or more reference signal (RS) resources. In an example, the WTRU may be configured with one or more RS resources (e.g., PT-RS, DMRS, CSI-RS, SSB, and so forth) and/or resource sets for performing one or more channel quality/quantity measurements (e.g., RSRP, RSRQ, SNR, SINR, PMI, CQI, RI, hypothetical BLER, ACK/NACK ratio, channel impulse response, doppler, and so forth).

The WTRU may be configured with measurement RS resources in one or more frequency ranges (FR). As an example, the WTRU may measure one or more CSI parameters in a first frequency range (e.g., FR1) and/or in a second frequency range (e.g., FR2). The WTRU may be configured with one or more associations between the reference signals in the first and the second frequency ranges. As an example, the WTRU may be configured with one or more reference signals in the first frequency range that are associated with one or more reference signals in the second frequency range. Alternatively, the WTRU may be configured with one or more reference signals with a first beamwidth (e.g., wide beamwidth) and one or more reference signals with a second beamwidth (e.g., narrow beamwidth). The WTRU may be configured with one or more associations between one or more RSs with the first beamwidth and one or more RSs with the second beamwidth.

In some cases, there may be trigger based and/or event based measurements to detect/determine blockages or to perform other related actions. In one case, a WTRU may be configured to measure one or more reference signals for beam failure prediction based on periodic, semi-persistent, or aperiodic configurations, wherein the WTRU may be configured or determined to derive the parameters for beam failure detection based on one or more events/triggers. In an example, the WTRU may be configured with one or more CSI parameters, wherein a (e.g., sudden or detectable over a period of time) change in one or more of the parameters could trigger the WTRU for measuring, estimating, predicting, and/or reporting corresponding beam failure detection/prediction parameters. For example, in case the WTRU detects a change in the measured value of a CSI parameter that is more than a (pre) configured/determined threshold (e.g., change from CQI level 15 to CQI level 10), the WTRU may trigger the event of measuring, estimating, and/or predicting respective parameters. In another example, the WTRU may be configured to only report Tx beams for which a drop in L1-RSRP has been measured by the WTRU with the sudden change consisting of a trigger for reporting as it may correspond to a blockage. The same sudden change in other channel parameters (e.g., PMI, AoA/AoD) may represent triggers for the WTRU to report the change in parameters and/or the corresponding beam for which the change has been detected by the WTRU.

The WTRU may be configured with or may determine an association between the measured CSI parameter, the events/actions to be triggered, and/or the parameters to be measured and/or reported. In an example, the WTRU may be configured with the association of one or more CSI parameters (e.g., in a first frequency range (e.g., FR1)) and one or more beam resources (e.g., in a second frequency range (e.g., FR2). As such, in case the WTRU detects a (sudden) change in a measured CSI parameter (e.g., in the first frequency range), the WTRU may determine to measure and/or report the quality/CSI corresponding to one or more associated beam resources (e.g., in the second frequency range).

In some cases a WTRU may be configured with one or more AI/ML models to perform beam failure predictions. The model may use WTRU measurements on reference signals (e.g., in a first frequency range) as input. The model may output the probability of blockage and/or beam/radio link failure for one or more beam resources (e.g., in a first and/or second frequency range). In an example, the WTRU may report AI/ML output to a base station. In another example, the WTRU may report assistance/supplementary information to the base station that are based on AL/ML output. As an example, the WTRU may report the beam resources that are predicted to have blockage/beam failure along with the beam resources that are predicted to be the best beams in case of blockage/beam failure.

Alternatively, the WTRU may be configured or determine to fallback to legacy CSI/beam reporting if AI/ML model blockage/beam failure prediction is not accurate enough and/or does not meet the KPI requirements as indicated by the base station. In an example, the WTRU may be configured with one or more parameters and respective thresholds and/or ranges for determining the accuracy and/or performance of the AI/ML model.

In some cases, a WTRU may be configured with one or more resources for reporting the derived (CSI) parameters and/or (e.g., probability of) beam failure/blockage prediction. As such, the WTRU may be configured to report one or more parameters based on the predicted (e.g., probability of) beam failure. The WTRU may report the beam failure result to the base station. There may be one or more of the parameters to report, such as those disclosed herein.

For example, one parameter to report may be a predicted blockage instance. For instance, the WTRU may report the predicted start of the blockage/beam failure based on, for example, AI/ML prediction output. The start instance may be indicated in time measurements units (e.g., milli-seconds, micro-seconds, and so forth). The start instances may be indicated based on the number of symbols/slots between uplink transmission including respective report (e.g., PUCCH/PUSCH) and the predicted time of the event.

For example, one parameter to report may be a predicted blockage duration. In an example, the WTRU may report the duration for which the blockage/beam failure is going to last, based on for example AI/ML prediction output. The time duration may be indicated in time measurements units (e.g., milli-seconds, micro-seconds, and so forth). The time duration may be indicated based on the number of symbols/slots. Alternatively, the WTRU may indicate/report the duration of the beam failure/blockage by using a flag indication. As such, the value zero (0) of the flag may indicate that the blockage/beam failure time duration is shorter than or equal to a threshold, and/or the value one (1) for the flag may indicate that the blockage/beam failure time duration is longer than a threshold.

For example, one parameter to report may be a predicted blockage probability. For instance, the WTRU may report the probability of the blockage/beam failure based on for example AI/ML prediction output. The probability may be indicated exactly based on the percentage value. The WTRU may indicate/report the probability of the beam failure/blockage by using a flag indication. As such, for example with a single-bit flag, the value zero (0) of the flag may indicate that the probability of the blockage/beam failure is smaller than or equal to a threshold, and/or the value one (1) for the flag may indicate that the probability of the blockage/beam failure is larger than a threshold.

For example, one parameter to report may be a predicted best beam after blockage. For example, the WTRU may predict/determine and report the best beam to be used in case blockage happens. As such, the WTRU may determine/predict (e.g., via AI/ML model) that which beam resource could be used in case one or more beam resources are going to have blockage/beam/radio link failure. Therefore, the WTRU may report one or more beam resources (e.g., CSI-RS resource indicator (CRI), SSB index, beam index, and so forth) as the predicted best beams.

For example, one parameter to report may be an expected blockage direction. For example, the WTRU may report one or more set of beam resources, wherein the WTRU predicts/determines the expected direction for the upcoming blockage/beam failure based on, for example, AI/ML model.

In some cases, the WTRU may determine one or more different types for the blockage/beam failure predictions (BFP) based on the combination of one or more measured parameters and according to the respective thresholds. As such, the WTRU may report the type of the beam failure prediction. Moreover, the WTRU may determine one or more modes of operation and WTRU behavior based on the determined BFP types.

In an example, there may be a first type of BFP (e.g., Type 1), where the WTRU may determine that the predicted blockage/beam failure time duration is shorter than respective threshold, while the predicted probability of blockage/beam failure is lower than respective threshold. The WTRU may determine the mode of operation accordingly. In an example, the WTRU may determine that blockage/beam failure may happen (e.g., predicted hypothetical BLER will be higher than a threshold). However, since the severity (e.g., predicted probability) and the duration are lower than respective thresholds, the WTRU may be able to recover form predicted blockage/beam failure without further actions. As such, the WTRU may determine to not report the predicted blockage/beam failure.

In an example, there may be a second type of BFP (e.g., Type 2), where the WTRU may determine that the predicted blockage/beam failure time duration is shorter than respective threshold, while the predicted probability of blockage/beam failure is larger than respective threshold. The WTRU may determine the mode of operation accordingly. In an example, the WTRU may determine that blockage/beam failure may happen (e.g., predicted hypothetical BLER will be higher than a threshold) with high probability but in short time instance. As such, the WTRU may determine to report the predicted blockage/beam failure and may send a suggestion/request (e.g., to base station) to switch to a determined/predicted best beam resources during the predicted blockage/beam failure.

In an example, there may be a third type of BFP, where the WTRU may determine that the predicted blockage/beam failure time duration is longer than respective threshold, while the predicted probability of blockage/beam failure is lower than respective threshold. The WTRU may determine the mode of operation accordingly. In an example, the WTRU may determine that blockage/beam failure may happen (e.g., predicted hypothetical BLER will be higher than a threshold) with low probability but in long time instance. As such, the WTRU may determine to report the predicted blockage/beam failure and may send a suggestion/request (e.g., to base station) to switch to a determined/predicted best beam resources during the predicted blockage/beam failure. Alternatively, after the first prediction, the WTRU may initiate a timer/counter and perform a second prediction on the probability of blockage/beam failure (e.g., via AI/ML model) after the timer/counter has expired. As such, the WTRU may determine to skip reporting the predicted blockage/beam failure in case the second prediction of probability of blockage/beam failure has decreased from the first prediction. Moreover, the WTRU may determine to report the predicted blockage/beam failure (e.g., to base station) in case the second prediction of probability of blockage/beam failure has increased from the first prediction.

In an example, there may be a fourth type of BFP (e.g., Type 4): The WTRU may determine that the predicted blockage/beam failure time duration is longer than respective threshold, while the predicted probability of blockage/beam failure is higher than respective threshold. The WTRU may determine the mode of operation accordingly. In an example, the WTRU may determine that blockage/beam failure may happen (e.g., predicted hypothetical BLER will be higher than a threshold) with high probability and during a long time. As such, the WTRU may determine to report the predicted blockage/beam failure. The WTRU may also send a suggestion/request (e.g., to base station) to switch to a determined/predicted best beam resources during the predicted blockage/beam failure.

In some cases, a WTRU may determine the validity/accuracy/performance of the blockage/beam failure prediction based on one or more parameters (e.g., as disclosed herein). The WTRU may explicitly report one or more beam resources with potential blockage/beam failure (e.g., beam resources with drop in RSRP). As such, the base station may send a second set of beam resources/CSI-RS resources (e.g., in the same or another frequency range) (e.g., excluding the beams reported by WTRU as beams with potential blockage/beam failure).

In some cases, the WTRU may monitor and measure parameters in the second set of beam resources. The WTRU may determine that the blockage/beam failure prediction module is not achieving the required performance and may report/suggest/request the base station to fallback/revert to the legacy beam management and beam failure detection/recovery procedures. In another case, the WTRU may suggest or request to switch to a first frequency range (e.g., FR1) (e.g., in case the WTRU is equipped with a dual-band system with both sub-6 GHZ and mmWave transceivers). The WTRU may request the fallback for a specific time window or until further notice/event/trigger.

Alternatively, the WTRU may be configured or receive a flag indication (e.g., from a base station), where the value zero (0) of the flag indicates legacy beam failure detection/recovery procedure, and the value one (1) of the flag indicates beam failure prediction (e.g., via AI/ML).

In some cases, a WTRU may be configured to monitor for a potential beam (e.g., a receiver beam, a transmitter beam, or a beam-pair) blockages. The monitoring may include detection of current blockages and/or prediction of upcoming beam blockages. For example, a WTRU may perform measurements to determine whether a beam will suffer from a blockage or at what time a beam will suffer a blockage or the duration of an upcoming blockage or the identity of one or more beams that may be impacted by the blockage. The WTRU may use an AI/ML model to determine or predict if a beam will suffer a blockage. Such an AI/ML model may be dedicated to blockage detection and/or prediction or may also be used for other functions.

In some cases, a base station may determine whether one or more beams will suffer a blockage.

In some cases, both the WTRU and the base station may jointly determine if one or more beams suffer a blockage. For example, a WTRU may determine whether one or more UL beams may suffer a blockage and a base station may determine whether one or more DL beams may suffer a blockage. In another example, a WTRU may determine if a WTRU transmitter beam or WTRU receiver beam may suffer a blockage and the base station may determine if a base station transmitter beam or base station receiver beam may suffer a blockage.

A WTRU may be configured with resources on which to perform measurements to enable monitoring and prediction of beam blockage. The measurement resources may be quasi-collocated with a beam or beam-pair. The measurement resources may be associated with at least one beam or beam-pair.

A WTRU may be configured with thresholds to determine whether a beam or beam-pair is suffering from blockage or to predict whether a beam or beam-pair will suffer from blockage. The thresholds may be configured dynamically (e.g., via MAC CE) or semi-statically (e.g., via RRC). The WTRU may perform measurements on a beam or beam-pair, or associated beam or associated beam-pair, and compare the measurements to thresholds to determine whether to report a beam blockage to the base station. The measurements used to determine or predict a beam blockage may include at least one of: RSRP, L1-RSRP, SINR, RSRQ, RSSI, CQI, AoA/AoD, Doppler shift, Doppler spread, and/or delay spread. The WTRU may be configured with one or more differential thresholds from the base station against which measured/detected change from one measurement to the next measurement may be compared (e.g., L1-RSRP differential threshold, AoA/AoD differential threshold, CQI differential threshold, etc.) such that if the measured/detected change from one measurement to the next exceeds the corresponding differential threshold, the WTRU may determine that a beam or beam pair may experience a (predicted) blockage.

A WTRU may be configured with resources in a first frequency region to perform measurements and determine or predict blockage of beams or beam-pairs in a second frequency region. For example, a WTRU may be configured with resources in sub-6 GHZ to perform measurements on beams associated with beams in FR2. The measurements in the first frequency region may be compared to a set of thresholds that may be specific to the first frequency region. For example, a WTRU may have a set of CQI thresholds in the first frequency region that may differ from CQI thresholds in a second frequency region. This may account for the fact that a partial blockage in a first frequency region may indicate a complete blockage in a second frequency region.

A WTRU may be configured with blockage ratio thresholds. A WTRU may determine that a beam or beam-pair suffers from blockage if a blockage probability or a blockage ratio exceed a blockage probability threshold or a blockage ratio threshold. The WTRU may determine the actual, or predicted, blockage ratio as the percentage of time a beam or beam-pair is undergoing blockage or is predicted to undergo blockage. The WTRU may be triggered to report beam blockage when it determines that a beam or beam-pair suffers blockage. The WTRU may also report the blockage ratio to the base station.

In some cases a WTRU may receive an indication of beam blockage. A WTRU may monitor for a beam blockage indication or beam blockage indication response from the base station. Herein, a beam blockage indication may refer to either a beam blockage indication or a beam blockage indication response.

A WTRU may report the state of one or more beams, where the state may include at least one of: whether a beam is suffering a blockage; whether a beam is predicted to suffer a blockage at a later time; the probability that a beam will suffer a blockage over a period of time; a request to change beam or beam-pair; time period over which a beam is predicted to suffer from a blockage; and/or time period over which to change a beam or beam pair. In an example, for a predicted blockage, the resulting degradation in channel conditions may only be measured at a time t+N in the future (e.g., where N may be measured in number of slots or time units, such as ms). As a result, the resulting beam change may only be required/activated at a future time instance. Upon transmission of such a report, a WTRU may monitor for a beam blockage indication/confirmation from the base station. The WTRU may also monitor for a beam blockage indication from a base station indicating the base station-determined state of one or more beams in the event that the blockage detection/prediction may be done at the base station.

A WTRU may adapt its beam blockage indication monitoring. For example, the WTRU may use a first monitoring pattern if it has not transmitted a beam blockage report to the base station and the WTRU may use a second monitoring pattern if it has transmitted a beam blockage report to the base station. The WTRU may use the second monitoring pattern for a fixed period of time after transmitting the beam blockage report to the base station.

The WTRU may receive the beam blockage indication via DCI, MAC CE, HARQ feedback, and/or RRC. In one instance, the beam blockage indication may be received via DCI. The WTRU may monitor an existing and/or dedicated or new DCI format or resource specifically designed/modified for beam blockage indication. The WTRU may be configured to know when to monitor the DCI for beam blockage indication. In one instance, the beam blockage indication to the WTRU may be implicit. The WTRU may be configured with a dedicated or new RNTI to decode the DCI. In an example, the urgent beam change indication may be scrambled with the CS-RNTI.

The beam blockage indication message may indicate to the WTRU that at least one of DL Rx, DL Tx, UL Tx, UL Rx beam or a beam-pair, may be changed. The beam blockage indication indicating a beam change may include at least one or more pieces of information.

For example, the beam blockage indication message may include that an original beam or beam-pair that may be suffering blockage. This may be indicated via an index or via an associated RS resource.

For example, the beam blockage indication message may include a new beam or beam-pair to start monitoring or to tune to. For example, a beam blockage indication may trigger a WTRU to begin operating on a fallback beam or beam-pair. The configuration of the new or fallback beam or beam-pair may be pre-configured or may be included in the beam blockage indication. A WTRU may maintain one or more fallback beams or beam-pairs to use when a beam or beam-pair suffers from blockage.

For example, the beam blockage indication message may include a timing of the blockage. For example, this may include the start or stop time of a blockage. For example, this may include the start or stop times to use a new (or fallback) beam or beam-pair.

For example, the beam blockage indication message may include a duration of the blockage.

For example, the beam blockage indication message may include a duration of use of a new (e.g. fallback) beam or beam-pair. For example, the timing of when to revert to the original beam or beam-pair may be included in the beam blockage indication.

For example, the beam blockage indication message may include a set of resources associated with the new beam or beam-pair. This may include PDCCH, PUCCH, CG, SPS, RS (e.g. CSI-RS) resources and the like.

For example, the beam blockage indication message may include a set of resources on which to perform measurements. For example, the resources may enable efficient use of a new beam or beam-pair. In another example, the resources may enable the WTRU to perform measurements on the beam or beam-pair that may be undergoing blockage. The measurements on beams or beam-pairs that may be undergoing blockage may enable a WTRU to validate a predicted blockage.

For example, the beam blockage indication message may include a confirmation to change beam or beam-pair. For example, a WTRU may transmit a request to change beams or beam-pairs. Such a request may be triggered by the determination that a beam blockage is occurring or is predicted to occur or has a high probability to occur. Such a request may be included (explicitly or implicitly) in a report by the WTRU indicating the beam blockage or beam blockage probabilities of one or more beams or beam-pairs. After transmitting the request or report, the WTRU may monitor for a confirmation from the base station to change beams or beam-pairs.

For example, the beam blockage indication message may include an indication of activation or deactivation of blockage monitoring or prediction. For example, the WTRU may be requested to activate or deactivate a function using an AI/ML model used to predict beam blockage.

For example, the beam blockage indication message may include an indication to turn on/off or activate/deactivate another carrier, BWP, TRP or cell. For example, a WTRU may be indicated to activate a cell or carrier in a different frequency region (e.g. sub-6 GHZ). This may enable the WTRU to receive or transmit data while a beam is blocked in another frequency region. The activation may also enable a WTRU to perform measurements on a different set of beams. The measurements may be used to validate or monitor the predicted beam blockage. The request may include a period of time for which the activation/deactivation may be valid. In one solution, the activation/deactivation may be valid until further indication.

For example, the beam blockage indication message may include a request/indication to switch to/only use the sub-6 GHZ transceiver if the WTRU is equipped with a dual-band system with both sub-6 GHZ and mmWave transceivers: for a specified time window (e.g., as determined by ML model at base station); or indefinitely (until further indication).

For example, the beam blockage indication message may include an indication that the network has activated/deactivated a carrier, BWP, TRP, or cell.

For example, the beam blockage indication message may include an indication that the base station has switched to the sub-6 GHZ transceiver.

For example, the beam blockage indication message may include a blockage ratio. For example, the base station may determine the actual or predicated blockage ratio. The beam blockage indication may include the base station-derived actual or predicted blockage ratio. The actual blockage ratio may be used by the WTRU to validate a predicted blockage ratio.

For example, the beam blockage indication message may include an RRC configuration (e.g., cell ID, beam-specific information on Rx beam to use) to access a new target cell. Following detection/prediction of a blockage, the source base station serving the WTRU may initiate handover to a target base station, in which case, the WTRU may receive RRC configuration to access the target base station. The WTRU may then move its RRC config to the target base station and send Handover Complete message.

A WTRU may be pre-configured with any of the above information that may be included in a beam blockage message, for example, in an RRC configuration message.

A WTRU may validate a predicted blockage and may report to the base station the actual blockage statistics, and possibly how they compare to the predicted blockage statistics. The WTRU may subsequently assess the ML model prediction accuracy and determine whether to retrain and/or deactivate the ML model and revert back to legacy methods for beam management.

In some cases, a WTRU may be configured with a CQI threshold or CQI differential threshold for the purposes of predicting spatial domain blockage. One or more techniques herein may be applied equally to CQI threshold or CQI differential threshold. One or more techniques herein may be described in terms of CQI and are equally applicable to any measurement/statistic associated with channel including but not limited to SNR, SINR, RSRP, RSRQ, PMI, RI, LI, BLER, ACK/NACK ratio, channel impulse response, doppler etc.

In some cases, the WTRU may be configured with a first CQI threshold and a second CQI threshold. The WTRU may be further configured with a linkage between the CQI threshold and a frequency range. For example, the first CQI threshold may be linked to a first frequency range and the second CQI threshold may be linked to a second frequency range. When the WTRU performs spatial blockage detection and/or prediction on the first frequency range using the CQI measurement associated with the first frequency range, the WTRU may apply the CQI threshold linked to the first frequency range. When the WTRU performs spatial blockage detection and/or prediction on the second frequency range using CQI measurement associated with second frequency range, the WTRU may apply the CQI threshold linked to the second frequency range.

In some cases, the WTRU may be configured with a CQI multiplier. The WTRU may be configured to apply the CQI multiplier when the spatial blockage detection and/or prediction happens on a different frequency from the frequency where the CQI is measured. For example, when the WTRU performs spatial blockage detection and/or prediction on the second frequency range using the CQI measurement associated with the first frequency range, the WTRU may scale the CQI threshold associated with first frequency range by the CQI multiplier. In one case, a WTRU may be configured with different CQI multipliers based on the frequency range for which the prediction is performed and frequency range on which the CQI measurements are made.

In some cases, the WTRU may be configured with multiple CQI thresholds and CQI multipliers. The WTRU may be configured with rules to determine the CQI threshold and optionally CQI multipliers based on one or more of the following: the frequency range in which spatial blockage detection and/or prediction is performed; frequency range in which CQI measurements are made; frequency range for which CQI threshold is configured; and/or frequency range for which CQI multiplier is configured. For example, if the frequency range in which the beam blockage detection and/or prediction is performed is the same as the frequency range over which the CQI is measured, then the WTRU may select the CQI threshold associated with/configured for the frequency range. In this case the WTRU may not apply a CQI multiplier. In another example, if the beam blockage detection and/or prediction is performed in a first frequency range, but the CQI is measured over a second frequency range, then the WTRU may select the CQI threshold associated with the second frequency range and additionally apply the CQI multiplier configured. Possibly the CQI multiplier may be configured for translation between the second frequency range and the first frequency range. In an example, the WTRU may be configured with a CQI threshold corresponding to blockage detection/prediction in FR1 and a corresponding CQI multiplier to apply to the CQI threshold for operation in FR2. It may be up to the WTRU to apply the CQI multiplier to the CQI threshold.

In one case, the WTRU may apply the CQI multiplier always when configured. In one case, the WTRU may apply the CQI multiplier when it receives a request from the base station. In one case, the WTRU may apply the CQI multiplier only when one or more preconfigured conditions are satisfied. For example, the WTRU may be configured to apply CQI multiplier if the WTRU is configured with FR1 CSI-RS resources. For example, the WTRU may be configured to apply CQI multiplier if the WTRU is configured with FR1 UL resources to report blockage for FR2 beams. For example, the WTRU may be configured to apply CQI multiplier if the WTRU is configured with FR1 CSI-RS resources and receives a request for reporting blockage for FR2 beams. For example, the WTRU may be configured to apply CQI multiplier if the WTRU supports dual band (e.g., the WTRU may be equipped with a dual-band system with both FR1 (e.g., sub-6 GHZ transceiver) and FR2 (e.g., mmWave transceiver). The WTRU may choose to apply beam blockage prediction for FR2 using measurements on FR1 for optimizing power saving.

Similar techniques, as described herein, may be applied for CSI differential threshold. For example, if the difference between successive computed CQIs within a preconfigured time interval is above the CSI differential threshold the WTRU may be configured to report the CSI parameters (e.g., PMI, CQI, RI etc.) and/or the difference to the base station. Possibly the base station may use the report for prediction using AIML model at the base station. In another example, if the difference between successive computed CQIs within a preconfigured time interval is above the CSI differential threshold the WTRU may be configured to apply the CSI parameters (e.g., PMI, CQI, RI etc.) and/or the difference as input to the AIML model at the WTRU. In some instances, the WTRU may use the inference output of the AIML model for spatial blockage detection and/or prediction.

In one case, the WTRU may be configured with different actions based on multiple conditions associated with the CSI differential threshold. For example, when the difference between maximum and minimum computed CQIs within a preconfigured time interval is above the CSI differential threshold and the difference is negative (i.e., a decrease in CQI) the WTRU may indicate to the base station that the spatial blockage is detected. For example, when the difference between maximum and minimum computed CQIs within a preconfigured time interval is above the CSI differential threshold and the difference is positive (i.e., an increase in CQI) the WTRU may indicate to the base station that the spatial blockage is removed. Upon detection of a blockage by the ML model (e.g., at the WTRU), the WTRU may be configured to report to the base station the time stamp at which the blockage is detected.

In some cases, the WTRU may be configured to apply preprocessing to the input data before feeding it into the ML model. In one instance, the preprocessing may include filtering of input data. For example, the filtering may be based on the CQI threshold. For example, if the computed CQI is greater than the CQI threshold then the WTRU may be configured to report CSI parameters (e.g., PMI, CQI, RI etc.) to the base station. For example, the WTRU may be configured to report CQI to the network when the CQI is lower than the CQI threshold, possibly including in the report the CSI parameters (e.g., PMI, CQI, RI etc.) and the difference. For example, if the computed CQI is less than the CQI threshold then the WTRU may be configured to apply the CSI parameters (e.g., PMI, CQI, RI etc.) as input to the AIML model. In one case, the WTRU may be configured to input the computed CQI at preconfigured time intervals. In some instances, the WTRU may be configured to also input a time stamp associated with CSI-RS reception or reception time of reference CSI-RS resource associated with computed CQI. In some instance, the AIML model inference output may be used to detect and/or predict spatial blockage or beam failure.

In some cases, the WTRU may be configured to determine/measure/predict how long the spatial blockage is expected to last (e.g., a duration of spatial blockage). In one instance, the WTRU may use inference output of AIML model to determine the duration of spatial blockage. In one instance, the WTRU may use the historical CSI parameters (e.g., CQI, PMI, RI etc.) and the latest CSI parameters as input to the AIML model. In one instance, the WTRU may use a different AIML model architectures applicable for time series prediction including but not limited to RNN (Recurrent Neural Networks), LSTM (Long Short-Term Memory), GRU (Gated Recurrent Units) or transformer-type architectures.

In one case, the WTRU may be configured to report a spatial blockage only if the duration of spatial blockage is above a preconfigured threshold. In one instance, the threshold may be a function of beam recovery time. In one instance, the threshold may be a function of type (e.g., CBRA/CFRA) or periodicity of beam recovery resource.

In one case, the WTRU may be configured to include the predicted duration of blockage in the spatial blockage indication to the base station.

In some cases, the WTRU may be configured to determine/predict the size of the spatial blockage to the base station. For example, the size of the spatial blockage may be defined/configured as the number of beams affected/impacted due to the blockage. Possibly the WTRU may be preconfigured with different classes of blockage size, such as small, medium, large. These classes may be then associated with number of blocked beams as x, y and z respectively. As an example, x may be <=2, y may be few beams [3<=y<=10] and z may be many beams (e.g., z>10). Following detection of a blockage and determination of blockage size/impacted beams by the WTRU, the WTRU may only report x, y or z to the base station.

In some cases, the WTRU may be configured additional conditions to report CSI parameters and/or measured/computed change in CSI parameters (e.g., CQI below a threshold or change in CQI above a CQI differential threshold). In one case, the conditions may be associated with WTRU position/location. For example, the WTRU may determine/predict and/or report spatial blockage has occurred when the CQI drops below a threshold and the WTRU position doesn't change or the position change is below a threshold. In one case, the condition may be associated with change in channel measurement quantity in addition or alternative to change in CQI. For example, the parameters may be SNR, SINR, RSRP, RSRQ, PMI, RI, LI, BLER, ACK/NACK ratio, channel impulse response, doppler, etc. In one case, the condition may be associated with duration of CQI drop. For example, the WTRU may determine/predict and/or report spatial blockage has occurred when the CQI drops below a threshold for a duration longer than a preconfigured threshold.

In some cases, the WTRU may be configured to acquire the resources for transmitting the spatial blockage prediction. The WTRU may send scheduling request to the base station. In some instances, the resources for scheduling request may be specifically configured for indication of spatial blockage prediction. In one case, if there are no UL resources available or configured for spatial blockage prediction, the WTRU may be configured to multiplex the spatial blockage prediction report in any available UL resources. In some instances, the WTRU may include spatial blockage prediction report in PUSCH transmission. In some instances, the WTRU may include spatial blockage prediction report in PUCCH transmission. In some instances, the WTRU may include spatial blockage prediction report in MAC CE transmission. If no UL resource is available at the time to report (predicted) blockage and/or (predicted) change in channel quality measurements (e.g., SNR, SINR, RSRP, RSRQ, PMI, RI, LI, BLER, ACK/NACK ratio, channel impulse response, doppler etc.), the WTRU may repurpose UL resources dedicated to other UL assignments using UL physical channel (e.g., PUCCH, PUSCH). The WTRU may also send a scheduling request to base station and the WTRU may receive in PDCCH an UL resource to transmit a MAC CE message to base station, indicating the blockage and/or change in channel quality measurement.

At any time/stage in the process (e.g., during beam sweeping, beam measurement/reporting, obstacle detection/prediction, determination of impacted beams from obstacle detection/prediction, beam failure recovery, etc.), the WTRU may receive an indication/request from the base station to switch to a first frequency band (e.g., sub-6 GHZ transceiver) if it is operating in a second frequency band (e.g., mmWave). This indication may be received by the WTRU subsequent to the base station having switched to a different frequency band itself, possibly as a result of an ML model at the base station detecting blockage in the second frequency band and/or the base station having learned about (potential) blockages in the surroundings of the WTRU from other WTRU(s) within a distance close enough such that similar propagation conditions may be assumed.

Periodic measurement reporting may be done by the WTRU to identify serving beams that may possibly corresponding to obstacles/blockages. This may correspond to beams having undergone/detected/measured a change in any one or more of the channel/beam quality/quantity measurements (e.g., RSRP, RSRQ, SNR, SINR, PMI, CQI, RI, hypothetical BLER, ACK/NACK ratio, channel impulse response, doppler, and so forth). Following a detected/measured drop in any one or more of the channel/beam quality/quantity measurements, the WTRU may switch to another beam (e.g., use another Tx beam and/or Rx beam and/or beam pair) to perform/repeat beam quality/quantity measurements. The WTRU may determine to report any change in channel/beam quality/quantity measurements only after similar changes/drops have been recorded/measured in N instances (N≥1) for M beams (M≥1) where M may correspond to a Tx beam or Rx beam or beam pair.

There may be one or more conditions for the WTRU to trigger the WTRU measurement/reporting.

For example, one condition may be a drop in an L1-RSRP measurement. For example, a WTRU may measure/report L1-RSRP values for beams (e.g., Tx beams) only if sudden drop in RSRP measured by WTRU. In another example, a WTRU may report the set of beams (e.g., beam IDs) corresponding to the M ‘worst’ beams (M≥1) where drop in measured RSRP is more critical (e.g., drop in RSRP is greater than a preconfigured threshold).

For example, one condition may be a sudden change in AoA or AoD. For example, the WTRU may measure/report L1-RSRP values of Tx beams for obstacle detection/prediction for beams (e.g., Tx beams) only if sudden change in AoA or AoD detected. In another example, the WTRU may report beam IDs for beams where change is detected/measured.

For example, one condition may be a sudden change in measured channel parameters (e.g., drop in CQI, change in PMI). The WTRU may compute CSI parameters (PMI, CQI, RI) for the channel and send measurement reports to the base station upon detection/measurement of a sudden change in one or more CSI parameters (e.g., PMI, CQI, RI). In one instance, the WTRU may detect/measure a change in CQI value above a threshold from the previous measurement and report the change to the base station. In one instance, the WTRU may detect a sudden change in CQI value above a threshold (e.g., sharp drop within a small time window) and report the change to the base station. In one instance, the WTRU may only report a measured/detected change in channel condition (e.g., change in CQI value) to the base station if there has been no change in the WTRU position such that the WTRU may determine that the drop in CQI is possibly due to a blockage. In one instance, if the duration of the measured/detected drop in CQI is greater than a threshold, the WTRU may determine the likely underlying cause to be a blockage and report the drop in CQI to base station. In one instance, if a WTRU detects change in other channel parameters (e.g., change in PMI) in addition to change in CQI, it may determine that the changes are possibly due to a blockage

For example, one condition may be when the content of a WTRU reporting includes one or more of the following: Detected/measured value of the channel/beam quality/quantity measurement metrics (e.g., RSRP, RSRQ, SNR, SINR, PMI, CQI, RI, hypothetical BLER, ACK/NACK ratio, channel impulse response, doppler, and so forth); Detected/measured value of the change in channel/beam quality/quantity measurements of any one or more of the metrics disclosed herein; Beams impacted by the change in channel/beam quality/quantity measurements (e.g., which may include Tx beam index/identifier and/or Rx beam index/identifier and/or beam pair index/identifier); and/or a location to enable base station to localize blockage (e.g., which may enable base station to assist other WTRUs).

In some cases, legacy beam failure detection (BFD) and beam failure recovery (BFR), a beam failure is declared when the L1-RSRP of all BFD-reference signals (BFD-RSs) fall below a preconfigured threshold (e.g., rsrp-ThresholdSSB or rsrp-ThresholdBFR) a preconfigured number of times (beamFailureInstanceMaxCount) subject to a timer (e.g., beamFailureDetectionTimer). Such measurement and timer based BFR procedure can be too slow or not appropriate for the dynamic nature of beam-based communication systems using higher frequencies. To this end, AI/ML based beam quality/blockage predictions may be used to foresee possible beam failures and initiate BFR procedure and/or support the WTRU to request for more resources for BFR. AI/ML model may be located at the WTRU and/or base station. Further, the AI/ML model may be trained by the WTRU and/or trained by the base station and transferred to the WTRU

When a beam failure is predicted or blockage is detected for the current beam in use by the AI/ML model, a WTRU may initiate a beam change to a new predicted beam to provide better beam quality (e.g., predicted to provide the best L1-RSRP out of all the candidate beams the WTRU may be configured with).

Beam quality prediction or beam switching based on blockage detection/prediction may be enabled/disabled by the base station via RRC/MAC-CE signaling or DCI indication (e.g., 1 bit indication via MAC-CE or DCI indication, whereby bit value ‘1’ may signal the enabling of such beam switching or beam quality prediction, while bit value ‘0’ or no indication may signal disabling or not enabling such beam switching).

The WTRU may receive a candidate beam set and each beam resource in the candidate beam set may be configured with a unique preamble and PRACH resources.

Once a beam failure is detected/predicted and a new beam is predicted by the WTRU based on the AI/ML model, the WTRU may use one or more techniques described herein to indicate beam failure and the selected new beam.

The WTRU may indicate the beam failure and the new beam the WTRU intends to select and wait for the new beam indication confirmation from the base station.

The WTRU may transmit a preamble corresponding to the new beam predicted to provide the best beam quality (e.g., L1-RSRP, SINR, RSRQ). Alternatively, the WTRU may transmit a preamble corresponding to a new beam predicted to provide beam quality above a preconfigured threshold.

Upon transmitting the preamble, the WTRU may monitor for a new beam indication confirmation from the base station via a BFR PDCCH by monitoring a dedicated BFR CORESET during a monitoring window configured by the base station.

If the WTRU fails to detect BFR PDCCH during the monitoring window, WTRU may increase the transmit power based on power ramping step (e.g., powerRampingStep or powerRampingStepHighPriority) configured by the base station and retransmit the preamble.

Once the preamble is retransmitted by the WTRU, the WTRU may monitor for new beam indication confirmation via BFR CORESET during subsequent monitoring window configured by the base station. The WTRU may attempt power increase and retransmission of preamble a number of times (e.g., preambleTransMax) as configured by the base station.

If the WTRU fails to detect a new beam confirmation via BFR PDCCH, WTRU may switch for contention based random access-BFR (CBRA-BFR) procedure.

In an alternative approach, the WTRU may transmit the preamble corresponding to the best new determined/predicted beam based on AI/ML model and the WTRU may assume base station will make beam adjustments subjected to a processing time delay (T beam-switch). T beam-switch may be configured by the base station via RRC signaling or MAC CE indication. The WTRU may use the highest possible transmit power for the preamble transmission (e.g., determined based on e.g., powerRampingStep or powerRampingStepHighPriority).

In an alternative approach, the WTRU may indicate the AI/ML based predicted beam failure and the detected/predicted new beam to the base station via PUCCH or MAC CE resource. The PUCCH or MAC CE indication may be subject to availability of sufficient time between the beam failure prediction and the time beam failure is predicted to be taking place. The WTRU may be indicated/configured with the time requirement needed by the base station via RRC signaling/MAC CE indication to be able to use PUCCH or MAC CE indication for beam failure prediction and the new predicted beam.

Once a beam failure and a best beam out of configured candidate beams is predicted by the WTRU based on AI/ML model, the WTRU may use the following approach to indicate beam failure and select a new beam after measuring the beam quality of the predicted best beam or one, several or all the candidate beams the WTRU is configured with.

In one approach to indicate beam failure and select a new beam, the WTRU may monitor one, several, or all candidate beams or predicted best candidate beam(s) at the immediate subsequent candidate beam reception occasion after beam failure prediction. If the beam quality measurement of the predicted best candidate beam (e.g., L1-RSRP, RSRQ, SINR)≥a first preconfigured threshold, the WTRU may follow beam failure indication and recovery procedure with the predicted best candidate beam. The first preconfigured beam quality threshold that the predicted best candidate beam needs to satisfy may be configured by the base station via RRC signaling or MAC CE indication. Alternatively, the WTRU may use rsrp-ThresholdSSB configured for BFR procedure as the first threshold.

If the quality of the predicted best candidate beam (e.g., L1-RSRP, RSRQ, SINR) is less than the first threshold, the WTRU may select the best candidate beam based on beam quality measurements if this beam meets a second preconfigured threshold. The WTRU may perform beam failure indication and beam recovery procedure based on the selected best candidate beam. The second threshold may be configured by the base station via RRC signaling or MAC CE indication. Alternatively, WTRU may use rsrp-ThresholdSSB configured for BFR procedure as the second threshold.

The WTRU may perform beam failure indication and recovery procedure with the predicted new beam that satisfy the first threshold, or the best candidate beam based on beam measurements that satisfies the second threshold based on the following procedure. The WTRU may transmit the preamble corresponding to the new beam selected. The WTRU may monitor for new beam indication confirmation from the base station via a BFR PDCCH by monitoring a dedicated BFR CORESET during a monitoring window configured by the base station. The WTRU may repeat preamble transmission and monitoring for new beam indication monitoring with increased preamble transmit power. If the WTRU fails to receive new beam indication confirmation, the WTRU may resort to CBRA-BFR.

When a beam failure is predicted or blockage is detected/predicted by the AI/ML model for the current beam in use or for one or more beams in the candidate beam set the WTRU is configured with, the WTRU may follow one or more (e.g., combination) of the following (e.g., to support BFR): the WTRU may request for and receive additional CSI-RS resources and/or additional FR2 beam resources (e.g., excluding beams impacted by blockage); the WTRU may receive indication from base station to report on a subset of CSI-RS resources in the resource set (excluding the blockage/obstacle) for a given time duration (e.g., multiple slots); the WTRU may request for and receive one or more CSI-RS measurement and reporting configurations (e.g., CSI-RS resources, TCI-state) based on detected/predicted blockage at base station from FR1 measurements; the WTRU may send an Instant/Urgent beam change request to the base station possibly to the predicted best beam and may receive a confirmation to change a beam; the WTRU may receive an urgent beam change indication from the base station along with the best predicted beam to switch to; and/or the WTRU may request for and receive additional candidate beam(s) and/or new beam based on one or more approaches.

In one approach, the WTRU may indicate the beam failure prediction for the current beam in use and request for additional candidate beams by using one of the following: 1 bit indication via MAC CE or PUCCH; and/or by transmitting a preconfigured preamble.

In one approach, the WTRU may indicate the available candidate beams to the base station (e.g., as a bit map via MAC CE/PUCCH). Subsequently, the WTRU may receive an indication from the base station to switch to one of the beams indicated to be available via MAC CE/DCI. The base station may interpret the reception of available candidate beam(s) indication from the WTRU as an indication of the WTRU having detected/predicted a beam failure and requesting for a beam switch. The WTRU may be configured by the base station with a threshold corresponding to beam quality (e.g., L1-RSRP, SINR, RSRQ) to determine the availability/quality of candidate beams. Alternatively, WTRU may use ThresholdSSB configured for BFR procedure as the threshold for beam quality to determine the availability of candidate beams.

In one approach, the WTRU may be configured with a dedicated CORESET to receive PDCCH indicating a new beam and/or activation/configuration of additional candidate beam resources. A new beam may be indicated by indicating one of the beams indicated by the WTRU to be available (e.g., beam index is indicated via PDCCH). The WTRU may switch to activated new beam via PDCCH for subsequent transmission/reception.

The WTRU may receive an indication from base station to report beam quality measurements (e.g., L1-RSRP, RSRQ, SINR) of all or subset of candidate beams (e.g., excluding beams detected/predicted to be impacted by blockage by the AI/ML model) for a configured number of candidate beam monitoring instances. The WTRU may be preconfigured with the number of monitoring instances the beam quality measurements need to be reported to the base station via RRC signaling/MAC CE indication. Alternatively, the WTRU may be indicated the number of monitoring instances beam quality measurements need to be reported via CSI ReportConfig.

When a beam failure is predicted/blockage is detected for the current beam in use by the AI/ML model, the WTRU may request the base station to switch frequency band, for example switching the WTRU to FR1. The WTRU may send the request to base station via MAC CE or PUCCH signaling.

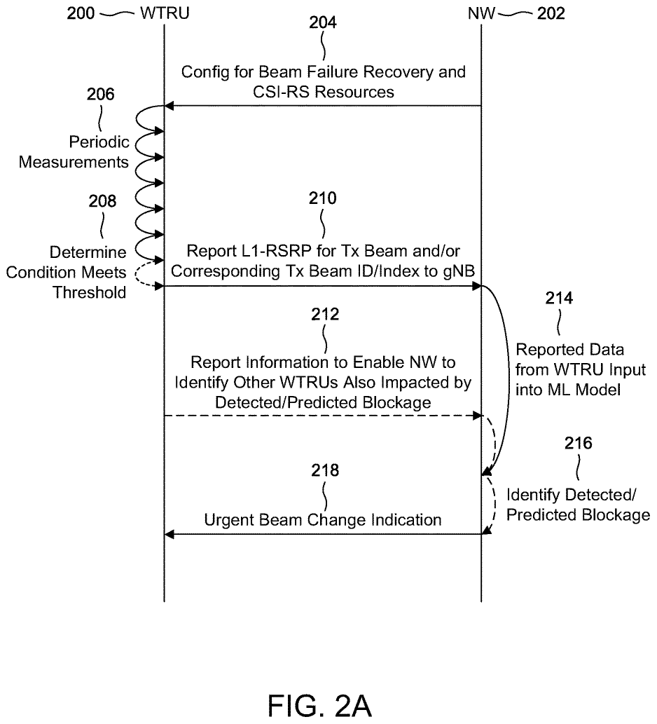

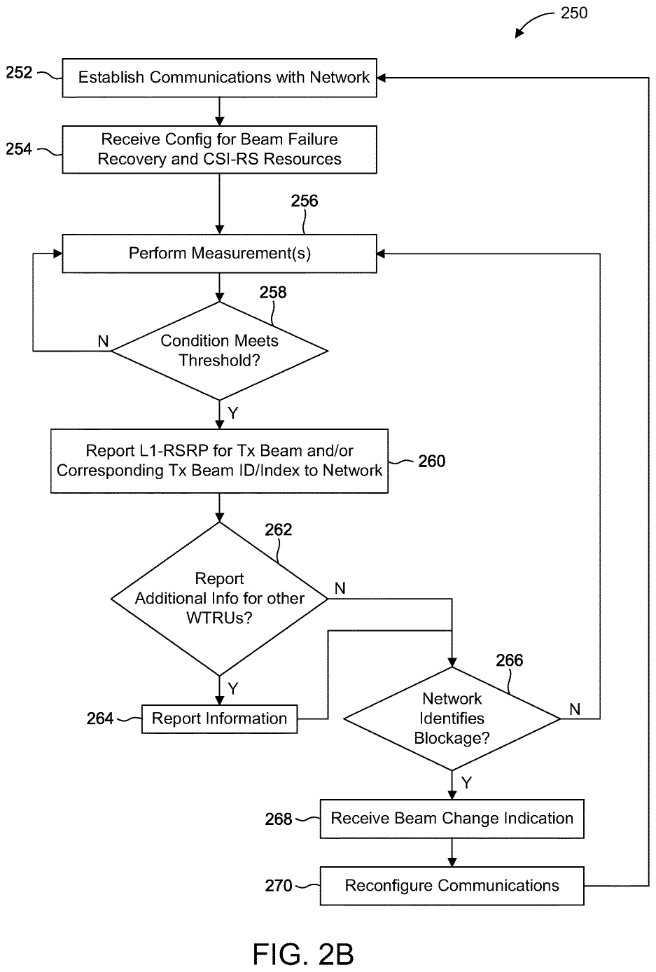

FIG. 2A illustrates an example of a machine learning model at a base station. In this example, a WTRU 200 receives a configuration of conventional beam failure recovery, and monitors beam failure detection (BFD) RSs and proceeds with beam failure recovery procedure if the WTRU 200 detects a number of beam failure instances is greater than a threshold. At 204, the WTRU 200 receives a configuration of CSI-RS resources/resource sets and CSI reporting for training AI/ML model for beam failure detection at the base station 202 (referred to generally as a base station or network node (NW)). The WTRU 200 performs periodic measurements to identify worst serving beams at 206, possibly corresponding to blockages/obstacles.

Responsive to detecting a change in a measured condition meets a threshold at 208, at 210 the WTRU 200 reports L1-RSRP value for Tx beam and/or corresponding Tx beam ID/index to the base station 202. Such conditions may include if a sudden drop in RSRP is measured (e.g. a change between two measurements greater than a threshold amount or percentage); and/or if a sudden change in AoA/AoD is detected (e.g. greater than a threshold number of degrees between subsequent measurements, or greater than a threshold number of degrees over a period of time (e.g. ≥5 degrees per second, ≥10 degrees per second, etc.)).

The WTRU 200 may report additional information to base station 202 in some embodiments at 212, such as: a WTRU location to enable base station to localize the blockage (e.g. GPS coordinates, triangulation information, visible access points, street address from a location database, or any other such information); and/or information to identify other WTRUs correlated with the WTRU. In some embodiments, the WTRU 200 may receive a configuration of SRS resources/resource sets from another WTRU (referred to sometimes as a first WTRU or first additional WTRU). The WTRU 200 may measure the SRS resources/resource sets and report the measurement result to the base station 202. In some instances, a relative TA configuration may be needed. In some instances, 1-bit reporting may be used to simply indicate whether the WTRU is close enough or not (e.g., based on RSRP/pathloss measurement with a threshold). In some instances, for 2-bit reporting, more granular information on the WTRU location may be provided (e.g., very close/close enough/far, such as based on signal strengths or RSRP/pathloss measurements relative to a plurality of thresholds).

The WTRU may exchange information with other WTRUs directly via the SL (e.g., Zone index, DL RS measurement and so on). This information may be forwarded to the base station 202 in some implementations.

In some instances, (such as where machine leaning is performed on the network side as shown in FIG. 2A), once a sufficiently long history is generated at a base station or other network node, the ML model prediction is turned on at 214. The base station 202 may utilize the received measurements and/or information from the WTRU 200, as well as any other WTRUs providing information directly or indirectly via the WTRU, as inputs to a machine learning system. For example, in one such implementation, the measurements may be vectorized and provided as inputs to a neural network. In another such implementation, the measurements may be used as an input to a SVM. The measurements may be preprocessed in many implementations, including normalization, dimension reduction, principal component analysis, etc.

In response to the ML system identifying a detected or predicted blockage or identifying a new beam configuration at 216, the base station 202 may transmit and the WTRU 200 may receive an urgent beam change indication based on the predicted beam failure at 218. The urgent beam change indication may be indicated to the WTRU 200 explicitly via an existing DCI format or a new/dedicated DCI format designed for urgent beam change indication. Implicit marking with urgent beam change indication may be scrambled with CS-RNTI in some implementations.

In some embodiments, the WTRU 200 may receive an indication from the base station to report on a subset of CSI-RS resources in the resource set (e.g., excluding the beams impacted by blockage) for a given time duration (e.g., multiple slots).

FIG. 2B is a flow chart of an implementation of a method 250 for predictive wireless communication management, using a machine learning model at a base station. In brief overview, at 252, a WTRU may establish communications with a network node such as a base station. At 254, the WTRU may receive a configuration for beam failure recovery and CSI-RS resources. At 256, the WTRU may perform one or more measurements of the wireless environment or characteristics. At 258, the WTRU may determine whether the measurement values or a condition meets a threshold. If not, 256-258 may be repeated. If so, at 260, the WTRU may report one or more measurements to the network node. In some implementations, at 262, the WTRU may be configured to receive additional information from one or more other WTRUs. If so, the WTRU may report the additional information to the base station at 264. At 266, the network node may use the received information or measurements to determine a blockage or interference or beam failure, or predicted future blockage or interference or beam failure. If not, 256-266 may be repeated. If so, the network node may provide a beam change indication to the WTRU at 268. The WTRU may reconfigure its communications with the network node at 270, and may repeat the process 250.

Still referring to FIG. 2B and in more detail, at 252, a WTRU may establish communications with a network node such as a base station. Establishing communications may include performing synchronization or authentication procedures, exchanging identifiers or other information, etc. In some implementations, the communications may be established via a first physical communication channel associated with a first spatial domain filter. For example, the communications may be established via a physical communication channel using beamforming.

At 254, the WTRU may receive a configuration for beam failure recovery and CSI-RS resources. In some implementations, the configuration may comprise one or more thresholds for signal measurements, such as RSRP thresholds, AoA/AoD angle thresholds, codebooks, reporting frequency, identifications of what measurements to report, or any other such information. For example, in some implementations, the configuration may comprise a CSI report configuration as discussed above.

At 256, the WTRU may perform one or more measurements of the wireless environment or characteristics. The measurements may be performed in accordance with the configuration, which may indicate which measurements to perform and/or how frequently to perform measurements. Measurements may comprise measuring a reference signal strength or power (RSRP), measuring noise levels, measuring interference levels on neighboring frequencies, or any other type and form of measurements. Measurements may be periodic, aperiodic, in response to received triggers, or any other repetition rate or combination of rates and triggers.

At 258, the WTRU may determine whether the measurement values or a condition meets a threshold. If not, 256-258 may be repeated. In some implementations, the WTRU may determine whether a measured value exceeds a threshold directly, such as a noise level exceeding a threshold, or a received signal strength being below a threshold. In other implementations, the WTRU may determine whether a change in values over successive measurements exceeds a threshold, such as a change in signal strength between a first measurement and a subsequent second measurement. In some implementations, a change may be averaged over several measurements (e.g. a sliding window, weighted average, or other such algorithm) to provide hysteresis or reduction of spurious measurements. In some implementations, multiple conditions and thresholds may be compared and may need to be met to trigger reporting (e.g. measurement A exceeding threshold A and measurement B exceeding threshold B; or three out of five measurements exceeding corresponding thresholds; etc.).

If the threshold(s) and/or condition(s) are met, at 260, the WTRU may report one or more measurements to the network node. Measurements may be reported via any suitable method, such as via a management frame, via a header or options field in a data frame, a PUCCH or PUSCH frame, or any other type and form of communication. Measurements may be provided as a string of values with predetermined positions, as parameter-value tuples, as a normalized vector, or any other type and format. In some implementations, the WTRU may report L1-RSRP for each Tx beam and/or a corresponding Tx beam ID or index number.

In some implementations, at 262, the WTRU may be configured to receive additional information from one or more other WTRUs. For example, one or more additional WTRUs may report measurements via a sidelink communication to the WTRU. In such implementations, the WTRU may report the additional information to the base station at 264. Although shown after 258-260, in some implementations, information may be received from other WTRUs at any time, and the WTRU may be configured to either buffer the information for reporting in response to a condition meeting a threshold at 258; or forward the information immediately (or at a predetermined time, such as a subsequent uplink time). Accordingly, 264 may occur at any point after 254.

At 266, the network node may use the received information or measurements to determine a blockage or interference or beam failure, or predicted future blockage or interference or beam failure. As discussed above, the network node may provide the received information or measurements as inputs to a machine learning model, such as a neural network or SVM or similar classifier or predictive model. In some implementations, the network node may perform one or more pre-processing steps, such as normalization, dimension reduction, filtering, truncation, scaling, or any other type and form of pre-processing.

If no interference or beam failure is detected or predicted, 256-266 may be repeated. If interference or beam failure is detected or predicted, the network node may provide a beam change indication to the WTRU at 268. The beam change indication may be transmitted via any suitable method, such as a management frame, a single bit flag, an array of beam suitability values, or other such methods. The indication may comprise one or more of a predicted blockage duration, a predicted time, a blockage probability, a predicted blockage direction, a predicted best beam after the blockage, an identification of beams or channels suffering interference, an identification of beams or channels to utilize instead, a duration for which to utilize the beams or channels before returning or switching to a fallback channel or beam, a fallback resource (e.g. beam, channel, or operating mode) in case the predicted or selected beam or channel does not work, resources for the new channel or beam including PDCCH, PUCCH, CCG, SPS, RS resources, or any other type and form of information.

The WTRU may reconfigure its communications with the network node at 270, and may repeat the process 250. For example, the WTRU may switch to using a predicted best beam or indicated channel or beam, and may resume or reestablish communications. In some implementations, 252 and 254 may be skipped, as communications may not need to be reestablished, and the configuration or resource identifications may be received at 268.

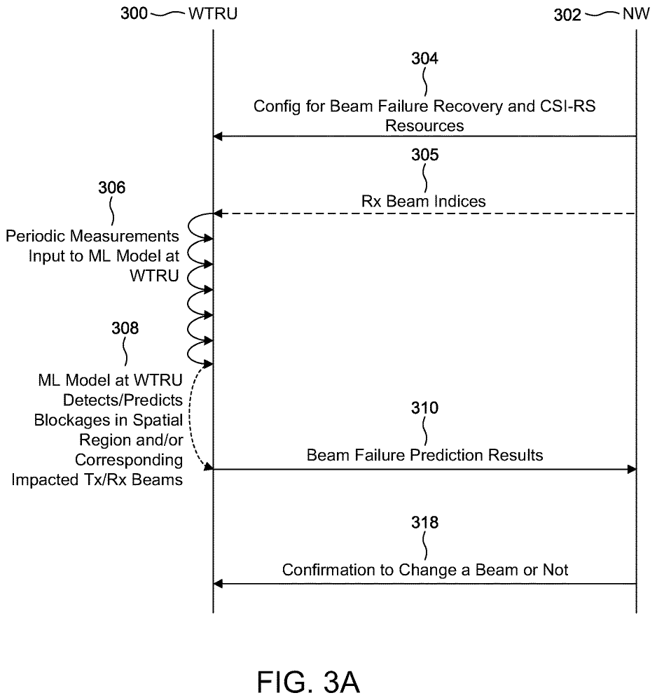

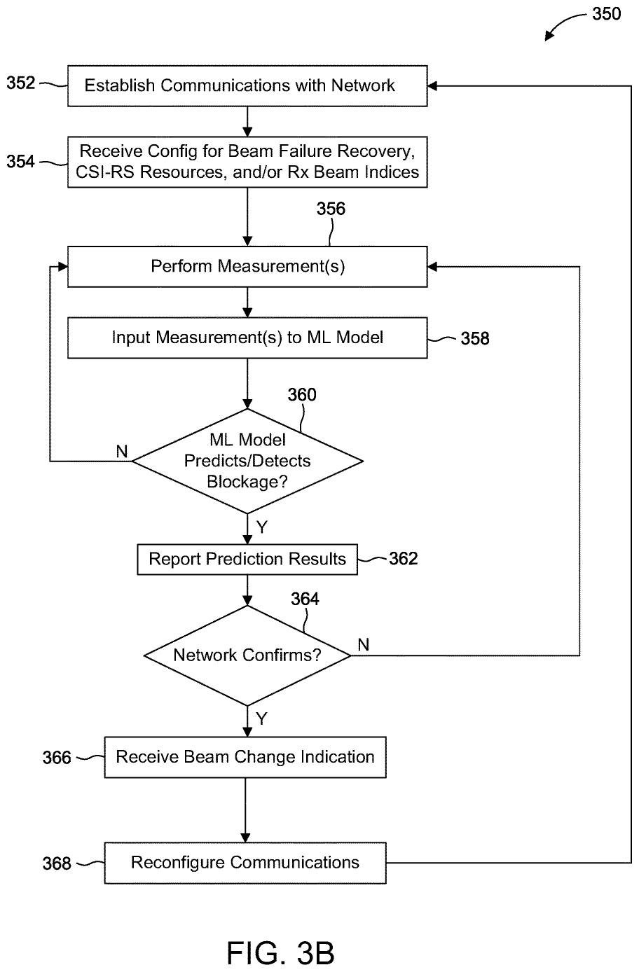

FIG. 3A illustrates an example of a machine learning model at a WTRU 300. In this example, the WTRU 300 receives a configuration of conventional beam failure recovery and monitors beam failure detection (BFD) RSs and proceeds with a beam failure recovery procedure if the WTRU detects a number of beam failure instances greater than a threshold.

For example in some implementations, at 304 the WTRU 300 receives a configuration of CSI-RS resources/resource sets and CSI reporting for training AI/ML model for beam failure detection at a base station 302. In some implementations at 305, the WTRU 300 may receive Rx beam indices from the base station 302.

The WTRU 300 performs periodic measurements at 306 to identify ‘worst’ serving beams, possibly corresponding to blockages/obstacles. For instance, the WTRU 300 may measure L1-RSRP values of Tx beams for obstacle detection/prediction, such as if a sudden drop in RSRP is measured by WTRU, and/or a sudden change in AoA or AoD is detected.

In implementations in which the ML model is executed at the WTRU 300, there may be input options for a ML model at the WTRU, such as: Tx beam index/RSRP/RSRP drop; Rx beam index; and/or WTRU location. At 308, the model at the WTRU may detect/predict blockages in a spatial region or regions; determine Tx beams that may be impacted by a blockage; and/or determine Rx beams that may be impacted by blockage.

The WTRU 300 may indicate a beam failure prediction result to the base station at 310. The content of the WTRU indication may lead to a beam change (e.g., based on the WTRU indication). The beam change may be implicitly decided (e.g., if duration/probability of predicted blockage is greater than a threshold). For instance, the content of the beam failure prediction result reported to the base station may include: Predicted blockage instance (e.g., start of blockage); Predicted blockage duration; Predicted blockage probability; Predicted best beam after blockage; and/or expected blockage direction (e.g., a set of beams). Based on the beam failure prediction result sent by the WTRU 300, the base station 302 may determine to change a beam/beam pair.

The WTRU 300 may receive a response 318 from the base station 302 confirming whether to change a beam or not.

Based on the response 318 from the base station 302, and/or based on the ML prediction message 310 from the WTRU 300, there may be a corresponding WTRU behavior, such as: the WTRU may proceed with an instant beam change possibly to the predicted best beam; if the WTRU detects beam failure, the WTRU may proceed with recovery procedure without measuring RSs to the predicted best beam (as indicated by ML model at WTRU); and/or if the WTRU detects beam failure, the WTRU may perform measurements on the predicted best beam (e.g., If the quality is greater than a threshold, the WTRU recovers with the best beam; e.g., If the quality is less than the threshold, the WTRU measures other candidate beams and recovers with the best beam).

FIG. 3B is a flow chart of an implementation of a method 350 for predictive wireless communication management, using a machine learning model at a WTRU. In brief overview, at 352, a WTRU may establish communications with a network node such as a base station. At 354, the WTRU may receive a configuration for beam failure recovery and CSI-RS resources. At 356, the WTRU may perform one or more measurements of the wireless environment or characteristics. At 358, the WTRU may input the measurements to a machine learning model. At 360, the WTRU may determine whether the machine learning model indicates or predicts a blockage or interference or beam failure. If not, 356-360 may be repeated. If so, at 362, the WTRU may report one or more prediction results to the network node. At 364, in some implementations, the WTRU may receive an indication from the network node either confirming or rejecting the prediction or indication of blockage (or confirming or rejecting switching to an alternate communication path or beam). If the prediction or change is rejected, 356-364 may be repeated. If the prediction or change is confirmed, at 366, in some implementations, the WTRU may receive an indication to change communication path or beams. At 368, the WTRU may reconfigure communications with the base station in accordance with the beam change indication.

Still referring to FIG. 3B and in more detail, at 352, a WTRU may establish communications with a network node such as a base station. Establishing communications may include performing synchronization or authentication procedures, exchanging identifiers or other information, etc. In some implementations, the communications may be established via a first physical communication channel associated with a first spatial domain filter. For example, the communications may be established via a physical communication channel using beamforming.

At 354, the WTRU may receive a configuration for beam failure recovery and CSI-RS resources. In some implementations, the configuration may comprise one or more thresholds for signal measurements, such as RSRP thresholds, AoA/AoD angle thresholds, codebooks, reporting frequency, identifications of what measurements to report, or any other such information. For example, in some implementations, the configuration may comprise a CSI report configuration as discussed above.

At 356, the WTRU may perform one or more measurements of the wireless environment or characteristics. The measurements may be performed in accordance with the configuration, which may indicate which measurements to perform and/or how frequently to perform measurements. Measurements may comprise measuring a reference signal strength or power (RSRP), measuring noise levels, measuring interference levels on neighboring frequencies, or any other type and form of measurements. Measurements may be periodic, aperiodic, in response to received triggers, or any other repetition rate or combination of rates and triggers.

At 358, the WTRU may input the measurements to a machine learning model. As discussed above, the WTRU may provide the received information or measurements as inputs to a machine learning model, such as a neural network or SVM or similar classifier or predictive model. In some implementations, the WTRU may perform one or more pre-processing steps, such as normalization, dimension reduction, filtering, truncation, scaling, or any other type and form of pre-processing.

At 360, the WTRU may determine whether the machine learning model indicates or predicts a blockage or interference or beam failure. If not, 356-360 may be repeated.

If the machine learning model does indicate or predict a blockage or beam failure, at 362, the WTRU may report one or more prediction results to the network node. The prediction results may be reported via any suitable method, such as via a management frame, via a header or options field in a data frame, a PUCCH or PUSCH frame, or any other type and form of communication. In some implementations, the WTRU may include measurements or a subset of measurements (e.g. those used in the ML model's current prediction) for verification by the network node (e.g. in connection with measurements from other WTRUs, for example). Measurements may be provided as a string of values with predetermined positions, as parameter-value tuples, as a normalized vector, or any other type and format. In some implementations, the WTRU may report L1-RSRP for each Tx beam and/or a corresponding Tx beam ID or index number.

At 364, in some implementations, the WTRU may receive an indication from the network node either confirming or rejecting the prediction or indication of blockage (or confirming or rejecting switching to an alternate communication path or beam). If the prediction or change is rejected, 356-364 may be repeated.

If the prediction or change is confirmed, at 366, in some implementations, the WTRU may receive an indication to change communication path or beams. The beam change indication may be transmitted via any suitable method, such as a management frame, a single bit flag, an array of beam suitability values, or other such methods. The indication may comprise one or more of a predicted blockage duration, a predicted time, a blockage probability, a predicted blockage direction, a predicted best beam after the blockage, an identification of beams or channels suffering interference, an identification of beams or channels to utilize instead, a duration for which to utilize the beams or channels before returning or switching to a fallback channel or beam, a fallback resource (e.g. beam, channel, or operating mode) in case the predicted or selected beam or channel does not work, resources for the new channel or beam including PDCCH, PUCCH, CCG, SPS, RS resources, or any other type and form of information.

At 368, the WTRU may reconfigure communications with the base station in accordance with the beam change indication. For example, the WTRU may switch to using a predicted best beam or indicated channel or beam, and may resume or reestablish communications. In some implementations, 352 and 354 may be skipped, as communications may not need to be reestablished, and the configuration or resource identifications may be received at 366.

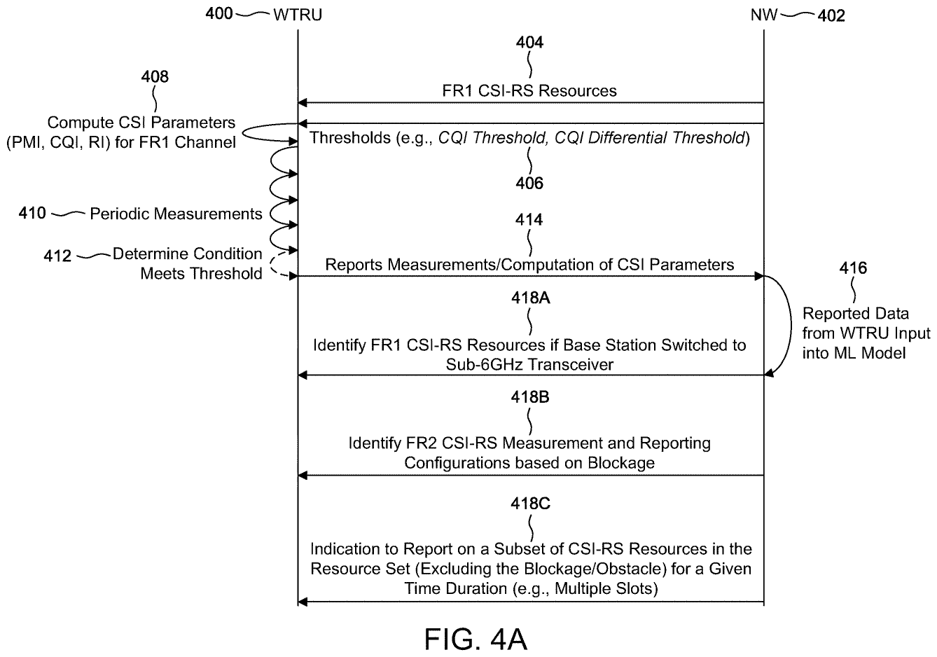

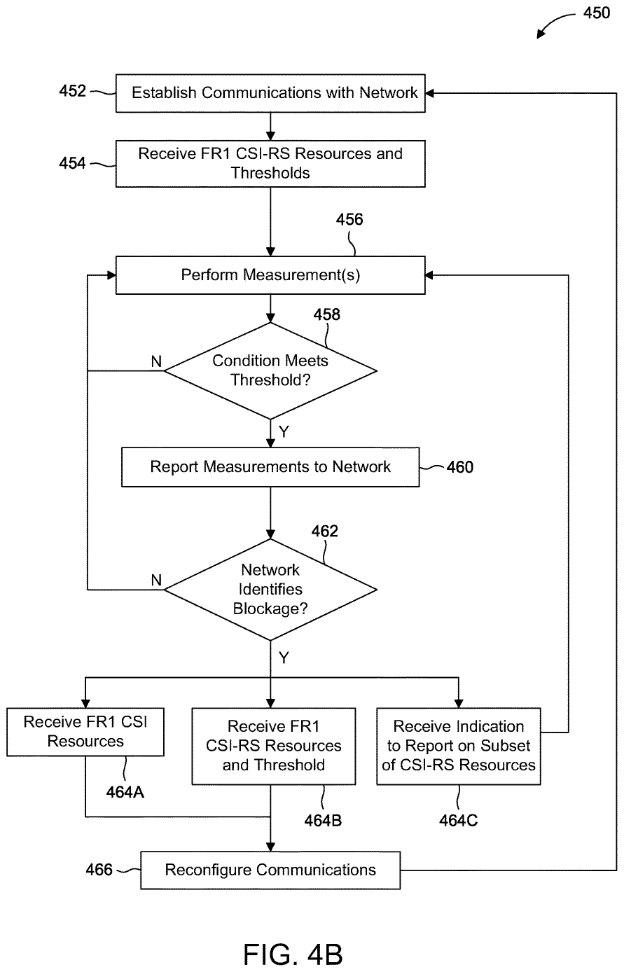

FIG. 4A illustrates an example of a machine learning model at a base station 402, where measurements in FR1 may result in blockage detection/prediction in FR2. In this example, at 404, a WTRU 400 receives one or more FR1 CSI-RS resources from the base station 402. At 406, the WTRU 400 receives one or more thresholds or differential thresholds associated with reported CSI parameters (e.g., CQI threshold, CQI differential threshold). CQI differential threshold/CQI threshold may account for the fact that a partial obstruction in sub-6 GHZ LOS link may result in complete obstruction/blockage of a corresponding mmWave beam(s).

At 408 in some implementations, the WTRU 400 computes CSI parameters (e.g., PMI, CQI, RI) for FR1 channel. At 410, the WTRU may perform measurements (e.g. periodically, aperiodically, semi-periodically, or any other such rate or in response to triggers). At 412, the WTRU 400 may determine whether one or more CSI parameters or a change in CSI parameters meets a threshold or condition (e.g., WTRU computes a change in CQI value from previous measurement, such as a change from CQI level 15 to CQI level 10. If the condition is met—e.g. if a computed CQI is less than a CQI threshold and/or change in computed CQI is greater than a CQI differential threshold and/or CQI drop duration is greater than a CQI drop duration threshold, for example, at 414 the WTRU 400 may report CSI parameters (e.g., PMI, CQI, RI) and measured/computed changes in CSI parameters (e.g., change in CQI) to the base station 402. Such a trigger for reporting may result in where, for example: the WTRU reports CSI parameters or a change in CSI parameters to the base station if WTRU is in the same position and measures a drop in channel quality measurements (e.g., drop in CQI); and/or the WTRU reports CSI parameters or a change in CSI parameters to the base station if change in PMI is detected in addition to change in CQI. In some implementations, if no UL resource is available at the time to report the drop in CSI parameters, then in some implementations, the WTRU 400 may repurpose UL resources dedicated to other UL assignments; the WTRU may send a scheduling request to the base station, where the WTRU may receive a PDCCH scheduling UL resource to transmit a MAC CE message to the base station; and/or the WTRU may transmit an indication on FR2 indicating beam failure prediction (e.g., 0: without prediction, 1: with prediction).

In implementations in which ML modeling occurs at the base station 402, then one or more reported measurements or changes between subsequent measurements (e.g., PMI, CQI, RI) may serve as input to the ML model at the base station at 416. Using the ML model, the base station 402 determines/predicts blockage and determines/predicts FR2 beams impacted by blockage; and/or the base station may determine to switch to using only the sub-6 GHZ transceiver for a time period if the base station has a dual-band system with both sub-6 GHZ and mmWave transceivers.

Responsive to the determination from the ML system, the base station 402 may transmit one or more indicators and/or resources at 418A-418C. For example, at 418A, the WTRU may receive from the base station the FR1 CSI-RS resources, if the base station switched to sub-6 GHZ transceiver. At 418B, the WTRU may receive from the base station the FR2 CSI-RS measurement and reporting configurations (e.g., CSI-RS resources, TCI-state) based on detected/predicted blockage at the base station. At 418C, the WTR may receive from the base station an indication to report on a subset of CSI-RS resources in the resource set, that may exclude the blockage/obstacle, for a given time duration (e.g., multiple slots). In some implementations, one or more of 418A-418C may be performed together.

In some instance of inter-base station handover, the WTRU 400 may receive RRC configuration (e.g., cell ID, beam-specific information on Rx beam to use) to access target cell, and the WTRU may move RRC config to target base station and send a Handover Complete message.

FIG. 4B is a flow chart of an implementation of a method 450 for predictive wireless communication management across frequency resources, using a machine learning model at a base station. In brief overview, at 452, a WTRU may establish communications with a network node such as a base station. At 454, the WTRU may receive a configuration for beam failure recovery and CSI-RS resources associated with a first carrier frequency. At 456, the WTRU may perform one or more measurements of the wireless environment or characteristics. At 458, the WTRU may determine whether the measurement values or a condition meets a threshold. If not, 456-458 may be repeated. If so, at 460, the WTRU may report one or more measurements to the network node. In some implementations, at 462, the network node may use the received information or measurements to determine a blockage or interference or beam failure, or predicted future blockage or interference or beam failure. If not, 456-462 may be repeated. If so, the network node may provide CSI resources for the first carrier frequency to the WTRU at 464A; may provide CSI-RS resources and thresholds for a second carrier frequency to the WTRU at 464B; and/or may provide an indication to report on a subset of CSI-RS resources at 464C. Responsive to the predicted beam failure, the WTRU may reconfigure its communications with the network node at 466, and may repeat the process 450.

Still referring to FIG. 4B and in more detail, at 452, a WTRU may establish communications with a network node such as a base station. Establishing communications may include performing synchronization or authentication procedures, exchanging identifiers or other information, etc. In some implementations, the communications may be established via a first physical communication channel associated with a first spatial domain filter. For example, the communications may be established via a physical communication channel using beamforming.

At 454, the WTRU may receive a configuration for beam failure recovery and CSI-RS resources associated with a first carrier frequency. In some implementations, the configuration may comprise one or more thresholds for signal measurements, such as RSRP thresholds, AoA/AoD angle thresholds, codebooks, reporting frequency, identifications of what measurements to report, or any other such information. For example, in some implementations, the configuration may comprise a CSI report configuration as discussed above.

At 456, the WTRU may perform one or more measurements of the wireless environment or characteristics. The measurements may be performed in accordance with the configuration, which may indicate which measurements to perform and/or how frequently to perform measurements. Measurements may comprise measuring a reference signal strength or power (RSRP), measuring noise levels, measuring interference levels on neighboring frequencies, or any other type and form of measurements. Measurements may be periodic, aperiodic, in response to received triggers, or any other repetition rate or combination of rates and triggers.

At 458, the WTRU may determine whether the measurement values or a condition meets a threshold. If not, 456-458 may be repeated. In some implementations, the WTRU may determine whether a measured value exceeds a threshold directly, such as a noise level exceeding a threshold, or a received signal strength being below a threshold. In other implementations, the WTRU may determine whether a change in values over successive measurements exceeds a threshold, such as a change in signal strength between a first measurement and a subsequent second measurement. In some implementations, a change may be averaged over several measurements (e.g. a sliding window, weighted average, or other such algorithm) to provide hysteresis or reduction of spurious measurements. In some implementations, multiple conditions and thresholds may be compared and may need to be met to trigger reporting (e.g. measurement A exceeding threshold A and measurement B exceeding threshold B; or three out of five measurements exceeding corresponding thresholds; etc.).

If the measurement values or condition meets the threshold, at 460, the WTRU may report one or more measurements to the network node. Measurements may be reported via any suitable method, such as via a management frame, via a header or options field in a data frame, a PUCCH or PUSCH frame, or any other type and form of communication. Measurements may be provided as a string of values with predetermined positions, as parameter-value tuples, as a normalized vector, or any other type and format. In some implementations, the WTRU may report L1-RSRP for each Tx beam and/or a corresponding Tx beam ID or index number.

In some implementations, at 462, the network node may use the received information or measurements to determine a blockage or interference or beam failure, or predicted future blockage or interference or beam failure. As discussed above, the network node may provide the received information or measurements as inputs to a machine learning model, such as a neural network or SVM or similar classifier or predictive model. In some implementations, the network node may perform one or more pre-processing steps, such as normalization, dimension reduction, filtering, truncation, scaling, or any other type and form of pre-processing.

If no interference or beam failure is detected or predicted, 456-462 may be repeated. If so interference or beam failure is detected or predicted, in some implementations, the network node may provide CSI resources for the first carrier frequency to the WTRU at 464A for use with a sub-6 GHZ transceiver. For example, in some implementations, the network node may determine to switch to using a sub-6 GHZ transceiver for a time period if the node has a dual band system with both sub-6 GHZ and mmWave transceivers as discussed above. Responsive to such switching, the network node may provide an indication to the WTRU that a switch has been made, and such indication may include CSI-RS resources.

In some implementations at 464B, the network node may provide CSI-RS resources and thresholds for a second carrier frequency to the WTRU. For example, based on determining that a first frequency band is experiencing or will likely experience interference via the ML system, the network node may indicate that the WTRU should utilize the second carrier frequency, and may provide CSI-RS measurement and reporting configurations for the second carrier frequency.

In some implementations, the network node may provide an indication to report on a subset of CSI-RS resources at 464C. For example, such a subset may comprise CSI-RS resources other than CSI-RS resources experiencing or that will likely experience a blockage or interference. The indication may include a time duration (e.g. number of slots) for which to use the subset of CSI-RS resources.

Responsive to the predicted beam failure, the WTRU may reconfigure its communications with the network node at 466, and may repeat the process 450. In some implementations, 452 and 454 may be skipped, as communications may not need to be reestablished, and the configuration or resource identifications may be received at 466.

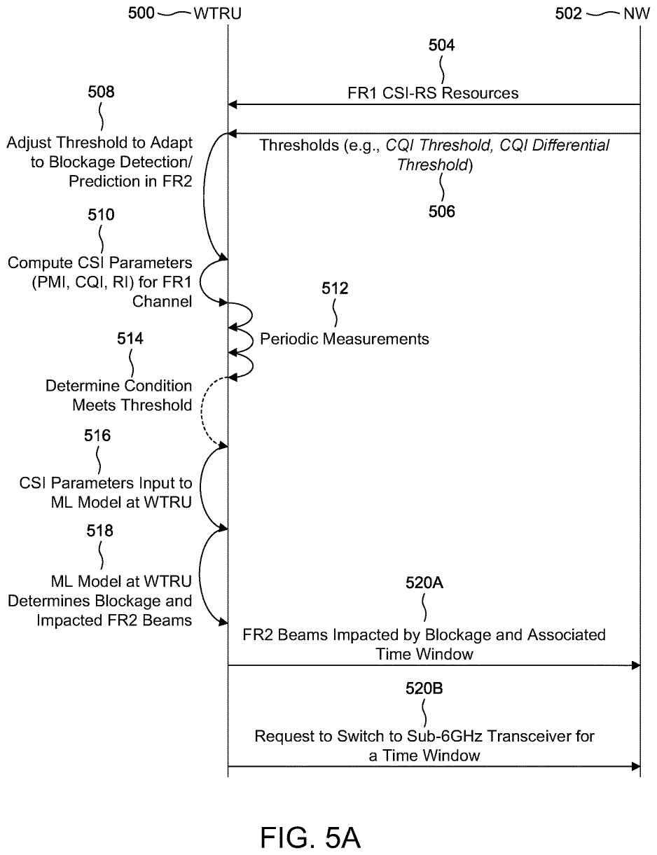

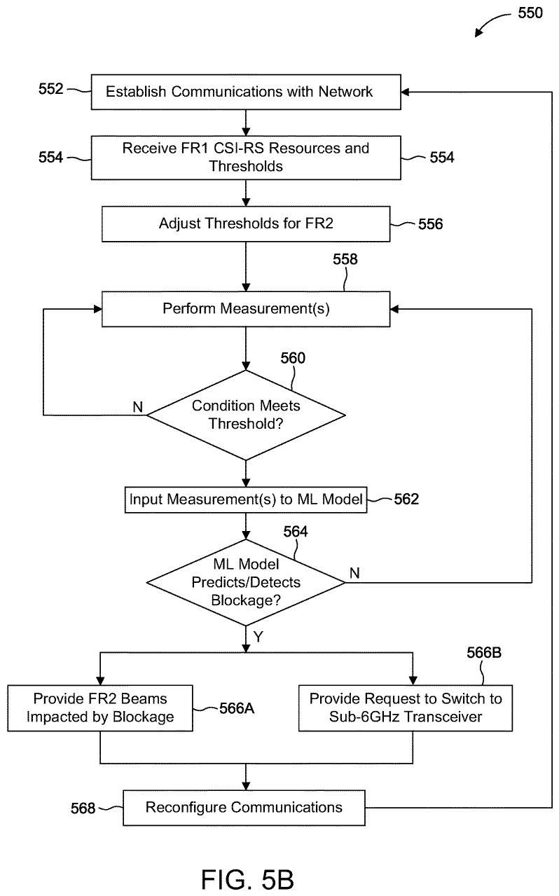

FIG. 5A illustrates an example of a machine learning model at a WTRU 500, where measurements in FR1 may result in obstacle detection/prediction in FR1. In this example, at 504, the WTRU 500 receives one or more FR1 CSI-RS resources from a base station 502. The WTRU 500 receives a configuration of CSI-RS resources/resource sets and CSI reporting for training an AI/ML model for beam failure detection at WTRU.

At 506, the WTRU 500 receives one of more thresholds or differential thresholds associated with reported CSI parameters (e.g., CQI threshold, CQI differential threshold, PMI threshold, PMI differential threshold, etc.). In one case, the CQI differential threshold/CQI threshold may account for the fact that a partial obstruction in sub-6 GHZ LOS may result in a complete obstruction/blockage of corresponding mmWave beam. In some implementations at 508, the WTRU may apply a multiplier to the CQI threshold/CQI differential threshold. The multiplier may be applied in specific situations, such as if the WTRU is configured with ML model for blockage detection/prediction in FR2 based on FR1 measurements; if the WTRU has a dual-band system with both sub-6 GHZ and mmWave transceivers; if the WTRU receives a request from the base station to report on FR2 beams (potentially) impacted by blockage; and/or if the WTRU receives UL resources from the base station to report on FR2 beams (potentially) impacted by blockage.

At 510, the WTRU 500 computes CSI parameters (e.g., PMI, CQI, RI) for FR1 channel. At 512, the WTRU 500 performs periodic measurements and determines whether a measurement or condition exceeds a threshold. For example, the WTRU may measure CSI parameters and identify a sudden change in one or more of the CSI parameters (e.g., drop in CQI level from previous measurement). If CQI is less than a CQI threshold or drop in CQI is greater than a CQI differential threshold, then at 516, the WTRU may input the parameters (e.g., PMI, CQI, RI) and/or measured/recorded change in CSI parameters and timestamp for change to an ML blockage model detector/predictor at the WTRU.

At 518, the ML model may detect/predict blocked LOS/obstacles in a spatial region for a time window; determine FR2 WTRU side Tx/Rx beams that may be impacted by blockage/obstacle; and/or may determine a location/size of the obstacle/blockage.

As a result of this modeling, the WTRU may perform one or more actions. For example, in some implementations, at 520A, the WTRU may report detected/predicted blocked FR2 beam indices to the base station 502 along with an associated time window. The WTRU 500 may request transmission or identification of additional FR2 beam resources. In another implementation, if the WTRU 500 has a dual-band system with both sub-6 GHZ and mmWave transceivers, at 520B, the WTRU may determine to only use the sub-6 GHZ transceiver for a time window as indicated by ML model. The WTRU 500 may send an explicit indication to base station 502 to switch to sub-6 GHZ transceiver usage exclusively over a given time window. The WTRU 500 may request FR1 CSI-RS resources from the base station 502 during the time window.

FIG. 5B is a flow chart of an implementation of a method for predictive wireless communication management across frequency resources, using a machine learning model at a WTRU. In brief overview, at 552, a WTRU may establish communications with a network node such as a base station. At 554, the WTRU may receive a configuration for beam failure recovery and CSI-RS resources for a first carrier frequency (e.g. FR1 CSI-RS resources and thresholds). At 556, in some implementations, the WTRU may adjust the thresholds for a second carrier frequency (FR2), such as applying a multiplier or scaling. At 558, the WTRU may perform one or more measurements of the wireless environment or characteristics. In some implementations, at 560, the WTRU may determine whether the measurements exceed a threshold or whether a condition has been satisfied. If not, 558-560 may be repeated. If so, at 562, the WTRU may input the measurements to a machine learning model. In some implementations, 560 may be skipped and all measurements may be provided to the machine learning mode. At 564, the WTRU may determine whether the machine learning model indicates or predicts a blockage or interference or beam failure. If not, 558-564 may be repeated. If so, in some implementations, at 566A, the WTRU may report detected/predicted blocked FR2 beam indices to the network node. In other implementations, at 566B, the WTRU may request to switch to a sub-6 GHZ transceiver for a time period. At 568, the WTRU may reconfigure communications in accordance with the reporting or request at 566A-566B.

Still referring to FIG. 5B and in more detail, at 552, a WTRU may establish communications with a network node such as a base station. The communications may be established via a first physical communication channel associated with a first carrier frequency (referred to as FR1). Establishing communications may include performing synchronization or authentication procedures, exchanging identifiers or other information, etc. In some implementations, the communications may be established via a first physical communication channel associated with a first spatial domain filter. For example, the communications may be established via a physical communication channel using beamforming.

At 554, the WTRU may receive a configuration for beam failure recovery and CSI-RS resources for the first carrier frequency (e.g. FR1 CSI-RS resources and thresholds). In some implementations, the configuration may comprise one or more thresholds for signal measurements, such as RSRP thresholds, AoA/AoD angle thresholds, codebooks, reporting frequency, identifications of what measurements to report, or any other such information. For example, in some implementations, the configuration may comprise a CSI report configuration as discussed above.

At 556, in some implementations, the WTRU may adjust the thresholds for a second carrier frequency (FR2), such as applying a multiplier or scaling. For example, the thresholds may be multiplied or scaled by a factor, or otherwise adjusted. In some implementations, the factor may be based on the configuration of the WTRU: for example, the WTRU may use a first factor if the WTRU is configured with an ML model for blockage detection or prediction in FR2 based on the FR1 measurements; may use a second factor if the WTRU has a dual-band system with both sub-6 GHZ and mmWave transceivers; may use a third factor if the WTRU receives a request from the network node to report on FR2 beams potentially impacted by a blockage or interference; and/or may use a fourth factor if the WTRU receives UL resources from the network node to report on FR2 beams potentially impacted by a blockage or interference. The factors may be the same or different, in various implementations.

At 558, the WTRU may perform one or more measurements of the wireless environment or characteristics. The measurements may be performed in accordance with the configuration, which may indicate which measurements to perform and/or how frequently to perform measurements. Measurements may comprise measuring a reference signal strength or power (RSRP), measuring noise levels, measuring interference levels on neighboring frequencies, or any other type and form of measurements. Measurements may be periodic, aperiodic, in response to received triggers, or any other repetition rate or combination of rates and triggers.

In some implementations, at 560, the WTRU may determine whether the measurements exceed a threshold or whether a condition has been satisfied. If not, 558-560 may be repeated. In some implementations, the WTRU may determine whether a measured value exceeds a threshold directly, such as a noise level exceeding a threshold, or a received signal strength being below a threshold. In other implementations, the WTRU may determine whether a change in values over successive measurements exceeds a threshold, such as a change in signal strength between a first measurement and a subsequent second measurement. In some implementations, a change may be averaged over several measurements (e.g. a sliding window, weighted average, or other such algorithm) to provide hysteresis or reduction of spurious measurements. In some implementations, multiple conditions and thresholds may be compared and may need to be met to trigger reporting (e.g. measurement A exceeding threshold A and measurement B exceeding threshold B; or three out of five measurements exceeding corresponding thresholds; etc.).

If the measurements exceed the threshold or the condition has been satisfied, at 562, the WTRU may input the measurements to a machine learning model. As discussed above, the WTRU may provide the received information or measurements as inputs to a machine learning model, such as a neural network or SVM or similar classifier or predictive model. In some implementations, the WTRU may perform one or more pre-processing steps, such as normalization, dimension reduction, filtering, truncation, scaling, or any other type and form of pre-processing. In some implementations, 560 may be skipped and all measurements may be provided to the machine learning mode.

At 564, the WTRU may determine whether the machine learning model indicates or predicts a blockage or interference or beam failure. If not, 558-564 may be repeated.

If the machine learning model indicates or predicts a blockage or interference or beam failure, in some implementations, at 566A, the WTRU may report detected/predicted blocked FR2 beam indices to the network node. The prediction results may be reported via any suitable method, such as via a management frame, via a header or options field in a data frame, a PUCCH or PUSCH frame, or any other type and form of communication. In some implementations, the WTRU may include measurements or a subset of measurements (e.g. those used in the ML model's current prediction) for verification by the network node (e.g. in connection with measurements from other WTRUs, for example). Measurements may be provided as a string of values with predetermined positions, as parameter-value tuples, as a normalized vector, or any other type and format. In some implementations, the WTRU may report L1-RSRP for each Tx beam and/or a corresponding Tx beam ID or index number.

In other implementations, at 566B, the WTRU may request to switch to a sub-6 GHZ transceiver for a time period. For example, in some implementations, the WTRU may determine to switch to using a sub-6 GHZ transceiver for a time period if the WTRU and base station have a dual band system with both sub-6 GHZ and mmWave transceivers as discussed above.

At 568, the WTRU may reconfigure communications in accordance with the reporting or request at 566A-566B. For example, the WTRU may switch to using a second carrier frequency, or may switch to using a sub-6 GHZ transceiver. In some implementations, the WTRU may reconfigure communications in response to an indication from the network node, which may be transmitted responsive to the indication or information provided at 566A-566B.

As disclosed herein, there may be one or more embodiments that address identification/reporting of degradation in beam quality/channel conditions, including: WTRU reports L1-RSRP values for beams (e.g., Tx beams) only if sudden change in measurement is detected; WTRU reports the corresponding beam ID; and/or WTRU reports drop in channel parameter (e.g., CQI) only if a drop is measured in addition to change in another channel parameter (e.g., PMI), or a drop is measured while WTRU position/location has not changed.

There may be one or more embodiments where information is determined/generated/transmitted/received to identify other WTRUs impacted by degradation, including: a WTRU may receive a configuration of SRS resources/resource sets from a first WTRU, measure the SRS resources/resource sets from the first WTRU and report the measurement result to the base station; and/or a WTRU may directly exchange information with other WTRUs via SL.

There may be one or more embodiments where the content of a WTRU reporting to a base station following degradation/blockage detection (e.g., when ML model at WTRU) may include: information on predicted blockage (e.g., duration, probability, predicted best beam following blockage, etc.); explicit indication of beams impacted by blockage; and/or urgent beam change request; request to switch operation to a second frequency band if WTRU is equipped with dual band transceivers.

In one or more embodiments, the content of a message reception at the WTRU (e.g., when ML model at base station) may include: confirmation to change a beam; additional CSI-RS resources (FR1 or FR2) to exclude impacted beams; and/or request to switch operation to a second frequency band.

Any of the techniques and/or approaches disclosed herein relating to handling obstacles/blockages also apply to any problem resulting in either partial or complete degradation in channel quality/beam quality measurements between a WTRU and a base station and/or TRP. Examples may include interference, fading, loss in coverage for non-terrestrial networks as a result of coverage ‘holes’, such as areas not serviced by any satellite.

Accordingly, in some implementations, the present disclosure is directed to a method for predictive wireless communication management. The method includes establishing, by a wireless transmit/receive unit (WTRU), communications with a network node via a first physical communication channel. The method also includes determining, by the WTRU, that a difference between measured characteristics of a reference signal transmitted by the network node to the WTRU via the first physical communication channel and measured characteristics of a previous reference signal transmitted by the network node to the WTRU via the first physical communication channel exceeds a reporting threshold. The method also includes transmitting, by the WTRU to the network node responsive to the determination, an identification of the measured characteristics of the reference signal. The method also includes receiving, by the WTRU from the network node via the first physical communication channel, an indication of predicted beam failure generated responsive to receipt of the identification of measured characteristics of the reference signal. The method also includes reconfiguring, by the WTRU responsive to receipt of the indication of predicted beam failure, communications with the network node to utilize a second physical communication channel.

In some implementations, the first physical communication channel is associated with a first spatial domain filter; and the second physical communication channel is associated with a second spatial domain filter.

In some implementations, the method includes receiving, by the WTRU from the network node, an identification of one or more characteristics of a reference signal for measurement and corresponding reporting thresholds. In a further implementation, the one or more characteristics comprise a reference signal received power (RSRP). In another further implementation, the one or more characteristics comprise an angle-of-arrival (AoA) or an angle-of-departure (AoD).

In some implementations, the method includes periodically measuring characteristics of reference signals transmitted by the network node to the WTRU via the first physical communication channel. In some implementations, the method includes transmitting location information of the WTRU to the network node. In some implementations, the method includes transmitting an identification of one or more additional WTRUs proximate to the WTRU to the network node.

In some implementations, the method includes receiving, by the WTRU from a second WTRU via a sidelink physical communication channel, an identification of characteristics of a reference signal, transmitted by the network node and measured by the second WTRU; and transmitting, by the WTRU to the network node via the first physical communication channel, the characteristics measured by the second WTRU. In a further implementation, the method includes forwarding, by the WTRU to the second WTRU via the sidelink physical communication channel, the indication of predicted beam failure received from the network node.

In another aspect, the present disclosure is directed to a wireless transmit/receive unit (WTRU) for predictive wireless communication management. The WTRU includes one or more processors in communication with one or more transceivers. The one or more processors are configured to: establish, via the one or more transceivers, communications with a network node via a first physical communication channel; determine that a difference between measured characteristics of a reference signal transmitted by the network node to the WTRU via the first physical communication channel and measured characteristics of a previous reference signal transmitted by the network node to the WTRU via the first physical communication channel exceed a reporting threshold; transmit, via the one or more transceivers to the network node responsive to the determination, an identification of the measured characteristics of the reference signal; receive, via the one or more transceivers from the network node via the first physical communication channel, an indication of predicted beam failure generated responsive to receipt of the identification of measured characteristics of the reference signal; and reconfigure, responsive to receipt of the indication of predicted beam failure, communications with the network node to utilize a second physical communication channel.

In some implementations, the first physical communication channel is associated with a first spatial domain filter; and the second physical communication channel is associated with a second spatial domain filter.

In some implementations, the one or more processors are further configured to receive, via the one or more transceivers from the network node, an identification of one or more characteristics of a reference signal for measurement and corresponding reporting thresholds. In a further implementation, the one or more characteristics comprise one or more of a reference signal received power (RSRP), an angle-of-arrival (AoA), and an angle-of-departure (AoD).

In some implementations, the one or more processors are further configured to periodically measure characteristics of reference signals transmitted by the network node to the WTRU via the first physical communication channel. In some implementations, the one or more processors are further configured to transmit location information of the WTRU to the network node. In some implementations, the one or more processors are further configured to transmit an identification of one or more additional WTRUs proximate to the WTRU to the network node.

In some implementations, the one or more processors are further configured to: receive, from a second WTRU via a sidelink physical communication channel, an identification of characteristics of a reference signal, transmitted by the network node and measured by the second WTRU; and transmit, via the one or more transceivers to the network node via the first physical communication channel, the characteristics measured by the second WTRU. In a further implementation, the one or more processors are further configured to forward, to the second WTRU via the sidelink physical communication channel, the indication of predicted beam failure received from the network node.

In another aspect, the present disclosure is directed to a method for predictive wireless communication management. The method includes establishing, by a wireless transmit/receive unit (WTRU), communications with a network node via a first physical communication channel associated with a first spatial domain filter. The method also includes measuring, by the WTRU, characteristics of a reference signal transmitted by the network node to the WTRU via the first physical communication channel. The method also includes determining, by the WTRU utilizing a trained model, that the measured characteristics indicate likely beam failure of the first physical communication channel. The method also includes, responsive to the determination, reconfiguring, by the WTRU, communications with the network node to utilize a second physical communication channel associated with a second spatial domain filter.

In still another aspect, the present disclosure is directed to a method for predictive wireless communication management. The method includes establishing, by a wireless transmit/receive unit (WTRU), communications with a network node via a first physical communication channel associated with a first carrier frequency. The method also includes determining, by the WTRU, that a difference between measured characteristics of a reference signal transmitted by the network node to the WTRU via the first physical communication channel and measured characteristics of a previous reference signal transmitted by the network node to the WTRU via the first physical communication channel exceeds a reporting threshold. The method also includes transmitting, by the WTRU to the network node responsive to the determination, an identification of the measured characteristics of the reference signal. The method also includes receiving, by the WTRU from the network node via the first physical communication channel, an indication of predicted beam failure for either of (i) the first physical communication channel or (ii) a second physical communication channel associated with a second carrier frequency. The method also includes reconfiguring, by the WTRU responsive to receipt of the indication of predicted beam failure, communications with the network node to respectively utilize (i) the second physical communication channel or (ii) a third physical communication channel associated with a third carrier frequency.

In still another aspect, the present disclosure is directed to a method for predictive wireless communication management. The method includes establishing, by a wireless transmit/receive unit (WTRU), communications with a network node via a first physical communication channel associated with a first carrier frequency. The method also includes measuring, by the WTRU, characteristics of a reference signal transmitted by the network node to the WTRU via the first physical communication channel. The method also includes determining, by the WTRU utilizing a trained model, that the measured characteristics indicate likely beam failure of a second physical communication channel with the network node associated with a second carrier frequency. The method also includes, responsive to the determination, providing, by the WTRU to the network node via the first physical communication channel, an indication of likely beam failure of the second physical communication channel.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-20. (canceled)

21. A method for predictive wireless communication management, comprising:
establishing, by a wireless transmit/receive unit (WTRU), communications with a network node via a first physical communication channel associated with a first spatial domain filter;
determining, by the WTRU, that a difference between a measured angle-of-arrival (AoA) or an angle-of-departure (AoD) of a reference signal transmitted by the network node to the WTRU via the first physical communication channel and a measured AoA or AoD of a previous reference signal transmitted by the network node to the WTRU via the first physical communication channel exceeds a reporting threshold;
transmitting, by the WTRU to the network node responsive to the determination, an identification of the measured AoA or AoD of the respective reference signals;
receiving, by the WTRU from the network node via the first physical communication channel, an indication of predicted beam failure based on the transmitted identification of measured AoA or AoD of the respective reference signals; and
reconfiguring, by the WTRU responsive to receipt of the indication of predicted beam failure, communications with the network node to utilize a second physical communication channel associated with a second spatial domain filter.

22. The method of claim 21, wherein transmitting the identification of the measured AoA or AoD of the respective reference signals further comprises:
transmitting, to the network node, location information of the WTRU and an identification of one or more additional WTRUs proximate to the WTRU.

23. The method of claim 22, wherein the identification of one or more additional WTRUs proximate to the WTRU includes a 1-bit reporting that a proximate WTRU is within a threshold range to be impacted by the determination or not.

24. The method of claim 22, wherein the identification of one or more additional WTRUs proximate to the WTRU includes a 2-bit reporting relevance of the determination for a proximate WTRU, based on the proximate WTRU's location in comparison with corresponding thresholds, as being one of likely impacted, potentially impacted or unlikely impacted.

25. The method of claim 23, further comprising:
exchanging information with the one or more additional WTRUs proximate to the WTRU, the exchanged information including one or more of a zone index or a downlink reference signal measurement.

26. The method of claim 22, further comprising:
receiving, from a second WTRU via a sidelink physical communication channel, an identification of the reference signal, or the previous reference signal, transmitted by the network node and corresponding AoA or AoD measurements by the second WTRU; and
transmitting, to the network node via the first physical communication channel, the AoA or AoD measurements by the second WTRU.

27. The method of claim 26, further comprising forwarding, by the WTRU to the second WTRU via the sidelink physical communication channel, the indication of predicted beam failure received from the network node.

28. A wireless transmit/receive unit (WTRU) for predictive wireless communication management, comprising:
one or more processors in communication with one or more transceivers;
wherein the one or more processors and the one or more transceivers are configured to:
establish, by a wireless transmit/receive unit (WTRU), communications with a network node via a first physical communication channel associated with a first spatial domain filter;
determine, by the WTRU, that a difference between a measured angle-of-arrival (AoA) or an angle-of-departure (AoD) of a reference signal transmitted by the network node to the WTRU via the first physical communication channel and a measured AoA or AoD of a previous reference signal transmitted by the network node to the WTRU via the first physical communication channel exceeds a reporting threshold;
transmit, by the WTRU to the network node responsive to the determination, an identification of the measured AoA or AoD of the respective reference signals;
receive, by the WTRU from the network node via the first physical communication channel, an indication of predicted beam failure based on the transmitted identification of measured AoA or AoD of the respective reference signals; and
reconfigure, by the WTRU responsive to receipt of the indication of predicted beam failure, communications with the network node to utilize a second physical communication channel associated with a second spatial domain filter.

29. The WTRU of claim 28, wherein transmitting the identification of the measured AoA or AoD of the respective reference signals further comprises transmitting, to the network node, location information of the WTRU and an identification of one or more additional WTRUs proximate to the WTRU.

30. The WTRU of claim 29, wherein the identification of one or more additional WTRUs proximate to the WTRU includes a 1-bit reporting that a proximate WTRU is within a threshold range to be impacted by the determination or not.

31. The WTRU of claim 29, wherein the identification of one or more additional WTRUs proximate to the WTRU includes a 2-bit reporting relevance of the determination for a proximate WTRU, based on the proximate WTRU's location in comparison with corresponding thresholds, as being one of likely impacted, potentially impacted or unlikely impacted.

32. The WTRU of claim 29, wherein the one or more processors and the one or more transceivers are further configured to:
exchange information with the one or more additional WTRUs proximate to the WTRU, the exchanged information including one or more of a zone index or a downlink reference signal measurement.

33. The WTRU of claim 29, wherein the one or more processors and the one or more transceivers are further configured to:
receive, from a second WTRU via a sidelink physical communication channel, an identification of the reference signal, or the previous reference signal, transmitted by the network node and corresponding AoA or AoD measurements by the second WTRU; and
transmit, to the network node via the first physical communication channel, the AoA or AoD measurements by the second WTRU.

34. The WTRU of claim 33, wherein the one or more processors and the one or more transceivers are further configured to:
forward, to the second WTRU via the sidelink physical communication channel, the indication of predicted beam failure received from the network node.
